(19) United States
(12) Patent Application Publication
(10) Pub. No.: US 2023/0259861 A1
(43) Pub. Date: Aug. 17, 2023

(54) METHODS AND SYSTEMS FOR SECURITY MATURITY DETERMINATION

(71) Applicant: KNOWBE4, INC., Clearwater, FL (US)

(72) Inventors: Greg Kras, Dunedin, FL (US); Perry Carpenter, Austin, AR (US)

(73) Assignee: KNOWBE4, INC., CLEARWATER, FL (US)

(21) Appl. No.: 18/108,484

(22) Filed: Feb. 10, 2023

Related U.S. Application Data
(60) Provisional application No. 63/311,421, filed on Feb. 17, 2022.

(51) Int. Cl. G06Q 10/0639

(52) U.S. Cl. CPC G06Q 10/06393

(57) ABSTRACT

Systems and methods are described for security maturity determination. Initially, first value for security knowledge level and second value for security awareness level of a user are determined. Further, third value for security culture level of a group of the user is determined. Thereafter, fourth value of security maturity of user is determined based at least on function of first value, second value, and third value. The user is then grouped into class of users comprising one or more additional users, wherein the fourth value of security maturity of the user falls within a predetermined range of security maturity values associated with class of users, class of users comprising one or more additional users. A phish prone percentage of user is benchmarked with phish phone percentage of one of one or more additional users of class of users. The benchmarking of phish prone percentage of user is displayed.

### RELATED APPLICATIONS

This patent application claims the benefit of and priority to U.S. Provisional Patent Application No. 63/311,421 titled “METHODS AND SYSTEMS FOR SECURITY AWARENESS MATURITY DETERMINATION,” and filed Feb. 17, 2022, the contents of all of which are hereby incorporated herein by reference in its entirety for all purposes

The present disclosure generally relates to determination of security maturity of a user of an organization.

### BACKGROUND OF THE DISCLOSURE

Organizations have recognized phishing attacks and social engineering attacks as one of the most prominent threats that can cause serious data breaches, including confidential information such as intellectual property, financial information, organizational information, and other important information. Attackers who launch phishing attacks and social engineering attacks may attempt to evade an organization's security apparatuses and tools and target its users (or employees). To prevent or to reduce the success rate of phishing attacks on users, organizations may conduct security awareness training programs for their users, along with other security measures. Through security awareness training programs, organizations actively educate their users on how to spot and report a suspected phishing attack. To evaluate the effectiveness of security awareness training programs, organizations may wish to evaluate the performance of users against other users of the organization.

### BRIEF SUMMARY OF THE DISCLOSURE

Systems and methods are provided for security maturity determination for a user. In an example embodiment, a method is described, which includes determining a first value for a security knowledge level of a user, determining a second value for a security awareness level of the user, determining a third value for a security culture level of a group of the user, and determining a fourth value of a security maturity of the user based at least on a function of the first value, the second value and the third value. In some embodiments, the method includes grouping the user into a class of users comprising one or more additional users, wherein the fourth value of the security maturity of the user falls within a predetermined range of security maturity values associated with the class of users, the class of users comprising one or more additional users. In some embodiments, the method includes benchmarking a phish prone percentage of the user with the phish phone percentage of one of the one or more additional users of the class of users and displaying the benchmarking of the phish prone percentage of the user.

In some embodiments, the method further includes determining the first value for the security knowledge level of the user based on one or more of results of quizzes or tests, detection of behaviors of the user, skills-based assessments of the user, a risk score of the user, and results of one or more simulated phishing campaigns of the user.

In some embodiments, determining the second value for a security awareness level of the user comprises classifying the user into a security awareness level comprising one or more of an undefined security awareness level, a compliance-driven security awareness level, a BAID security awareness level, and a behavior-shaped security awareness level.

In some embodiments, the method further includes determining the third value for the security culture level of the group of the user based at least on the group to which the user is assigned. In some embodiments, the method further includes determining the third value for a security culture level based on one or more of security policies of the group of the user, security communications to the group of the user, or security incentives offered to the group of the user. In some embodiments, the group of the user is the organization of the user.

In some embodiments, the predetermined range of security maturity values of the class of users comprises one or more of a lower bound of a security maturity value and an upper bound of a security maturity value. In some embodiments, grouping the user into the class of users comprises adding the user to the class of users.

In some embodiments, benchmarking the phish prone percentage of the user with the phish phone percentage of the one or more additional users comprises determining whether the phish prone percentage of the user is greater than or less than the phish phone percentage one or more users of the one or more additional users.

In some embodiments, displaying the benchmarking comprises creating a graphical representation showing a relationship between the phish prone percentage of the user and the phish prone percentage of one or more users of the class of users.

In another example implementation, a system is described which includes one or more servers. The one or more servers are configured to determine a first value for a security knowledge level of a user, determine a second value for a security awareness level of the user, determine a third value for a security culture level of a group of the user, and determine a fourth value of a security maturity of the user based at least on a function of the first value, the second value and the third value. In some embodiments, the one or more servers are configured to group the user into a class of users comprising one or more additional users, wherein the fourth value of the security maturity of the user falls within a predetermined range of security maturity values associated with the class of users, the class of users comprising one or more additional users. In some embodiments, the one or more servers are configured to benchmark a phish prone percentage of the user with the phish phone percentage of one of the one or more additional users of the class of users and display the benchmarking of the phish prone percentage of the user.

Other aspects and advantages of the disclosure will become apparent from the following detailed description, taken in conjunction with the accompanying drawings, which illustrate by way of example the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising a client device in communication with cloud service providers;

FIG. 1C and FIG. 1D are block diagrams depicting embodiments of computing devices useful in connection with the methods and systems described herein;

FIG. 2 depicts an implementation of some of an architecture of a system for security maturity determination, according to some embodiments;

FIG. 3A and FIG. 3B depict a dashboard including a series of radar plots visualizing security maturity over twelve users, according to some embodiments;

FIG. 4 depicts a radar plot visualizing an example of a security risk for a user, according to some embodiments;

FIG. 5A and FIG. 5B depict a flowchart for determining a security maturity of a user, according to some embodiments; and

FIG. 6A and FIG. 6B depict a flowchart for rewarding a user based on a security maturity of a user, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods for determination of security maturity of a user of an organization.

### A. Computing and Network Environment

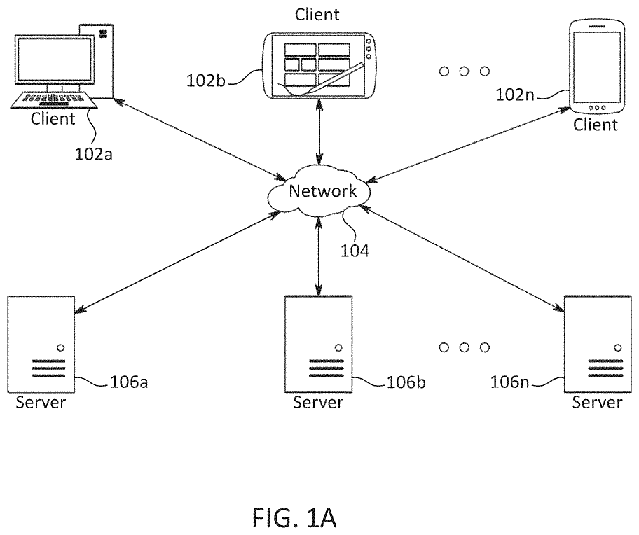

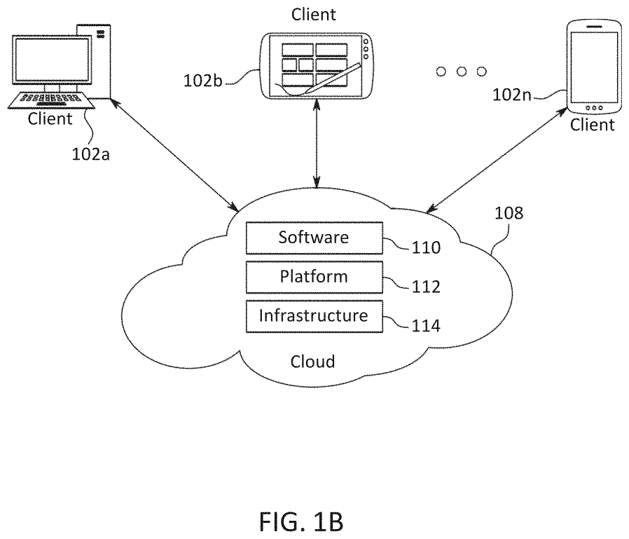

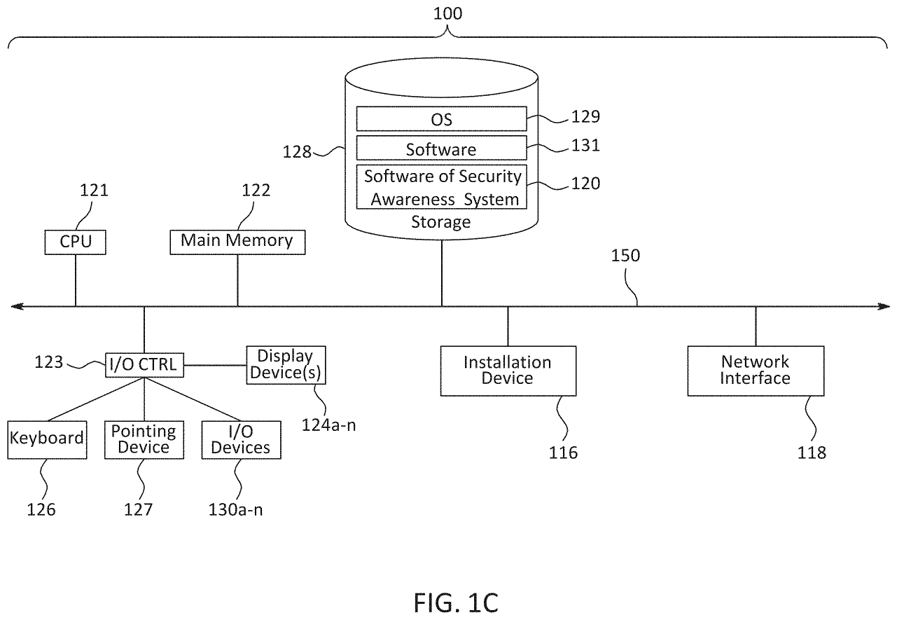

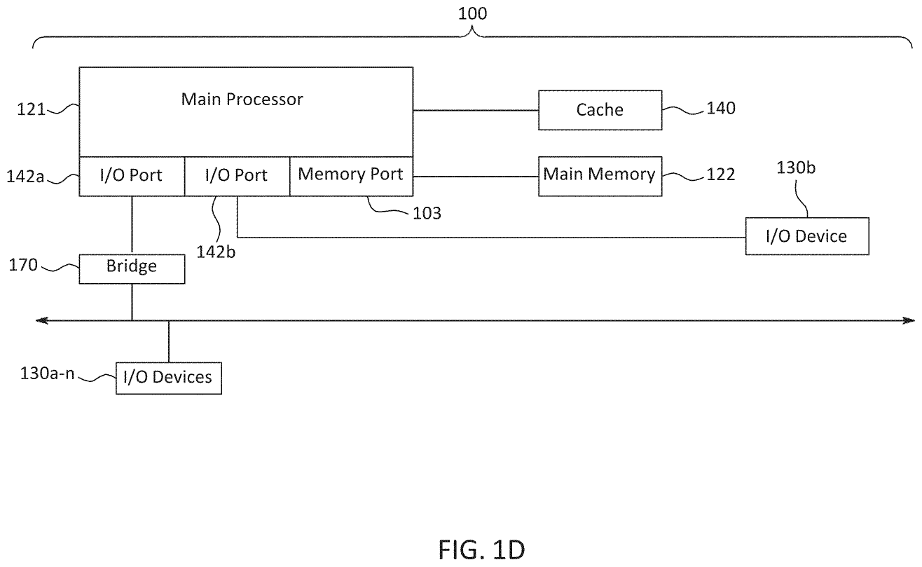

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel, or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., IPv4 and IPv6), or the link layer. The network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Wash.), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, Calif.; the Xen hypervisor, an open source product whose development is overseen by Citrix Systems, Inc. of Fort Lauderdale, Fla.; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 109 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers, or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g., Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g., Google Chrome, Microsoft Internet Explorer, or Mozilla Firefox provided by Mozilla Foundation of Mountain View, Calif.). Clients 102 may also access SaaS resources through smartphone or tablet applications, including e.g., Salesforce Sales Cloud, or Google Drive App. Clients 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or Application Program Interface (API) keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit (CPU) 121, and a main memory unit 122. As shown in FIG. 1C, a computing device 100 may include a storage device 128, an installation device 116, a network interface 118, and input/output (I/O) controller 123, display devices 124a-124n, a keyboard 126 and a pointing device 127, e.g., a mouse. The storage device 128 may include, without limitation, an operating system (OS) 129, software 131, and a software of a security awareness system 120. As shown in FIG. 1D, each computing device 100 may also include additional optional elements, e.g., a memory port 103, a bridge 170, one or more input/output (I/O) devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the central processing unit 121. Main memory unit 122 may be volatile and faster than storage 128 memory. Main memory units 122 may be Dynamic Random-Access Memory (DRAM) or any variants, including Static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile random access memory (NVRAM), flash memory non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the central processing unit 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the central processing unit 121 communicates directly with cache memory 140 via a secondary bus, sometimes referred to as a backside bus. In other embodiments, the central processing unit 121 communicates with cache memory 140 using the system bus 150. Cache memory 140 typically has a faster response time than main memory 122 and is typically provided by SRAM, BSRAM, or EDRAM. In the embodiment shown in FIG. 1D, the central processing unit 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the central processing unit 121 may use an Advanced Graphic Port (AGP) to communicate with the display 124 or the I/O controller 123 for the display 124. FIG. 1D depicts an embodiment of a computer 100 in which the central processing unit 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the central processing unit 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices 130a-130n may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation device 116 for the computing device 100. In still other embodiments, the computing device 100 may provide USB connections to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect, or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise storage device 128 (e.g., one or more hard disk drives or redundant arrays of independent disks) for storing an operating system or other related software, and for storing application software programs such as any program related to the software of security awareness system 120. Examples of storage device 128 include, e.g., hard disk drive (HDD); optical drive including a compact disc (CD) drive, DVD drive, or BLU-RAY drive; solid-state drive (SSD); USB flash drive; or any other device suitable for storing data. Some storage devices 128 may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem, or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Wash.; MAC OS and iOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g., the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g., the KINDLE family of devices by Amazon.com, or NOOK family of devices by Barnes & Noble, Inc. of New York City, N.Y.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU, and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Security Maturity Determination

The present disclosure generally relates systems and methods for determination of security maturity of a user of an organization.

An organization may facilitate a security awareness training program via a simulated phishing campaign. The organization may execute the simulated phishing campaign by sending out one or more simulated phishing messages to users of the organization and observe responses of the users to such simulated phishing messages. The organization may assess or evaluate a performance of a group of users against other users of the organization by sending the same simulated phishing messages to all users of the organization. The organization may evaluate performance results (i.e., the success rates and/or the failure rates) of the simulated phishing campaign. The aggregated result across multiple users in the organization may be used as a proxy for the performance of the organization as a whole. However, since different users in the organization may have varying levels of security maturity at any given time, using the performance results of the simulated phishing messages sent to the users with different security maturities may not give accurate or meaningful results. This may result in inaccurate assessments, leading to security awareness training programs that are unsuitable for the users in the organization.

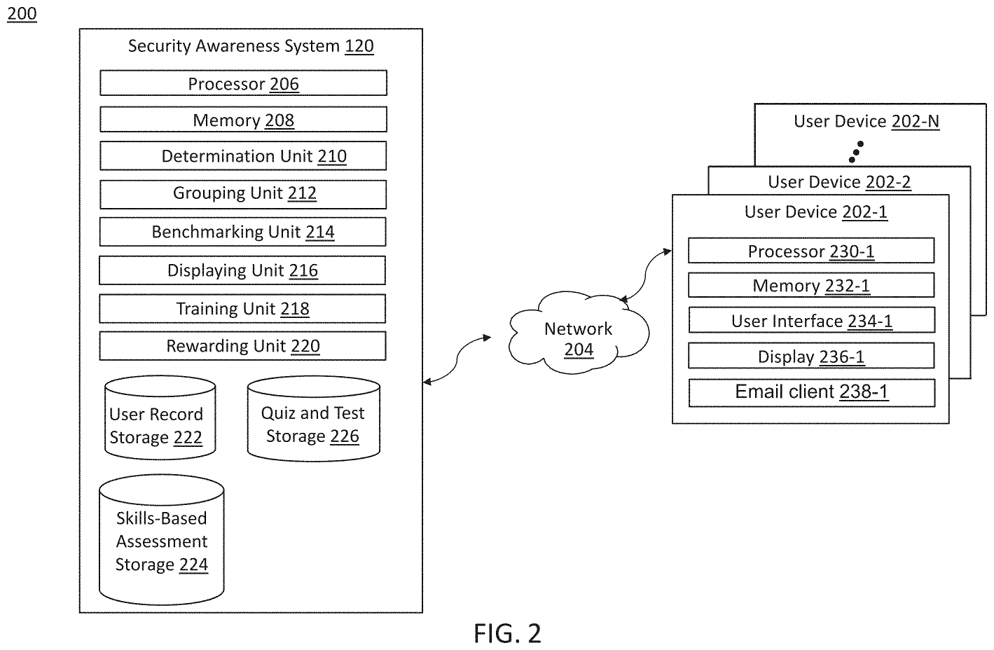

FIG. 2 depicts some of the architecture of an implementation of system 200 for security maturity determination, according to some embodiments. System 200 may include security awareness system 120, plurality of user devices 202-(1-N), and network 204 enabling communication between the system components for information exchange. Network 204 may be an example or instance of network 104, details of which are provided with reference to FIG. 1A and its accompanying description.

According to one or more embodiments, security awareness system 120 may be implemented in a variety of computing systems, such as a mainframe computer, a server, a network server, a laptop computer, a desktop computer, a notebook, a workstation, and any other computing system. In an implementation, security awareness system 120 may be implemented in a server, such as server 106 shown in FIG. 1A. In some implementations, security awareness system 120 may be implemented by a device, such as computing device 100 shown in FIG. 1C and FIG. 1D. In some embodiments, security awareness system 120 may be implemented as a part of a cluster of servers. In some embodiments, security awareness system 120 may be implemented across a plurality of servers, thereby, tasks performed by security awareness system 120 may be performed by the plurality of servers. These tasks may be allocated among the cluster of servers by an application, a service, a daemon, a routine, or other executable logic for task allocation. The term “application” as used herein may refer to one or more applications, services, routines, or other executable logic or instructions. Security awareness system 120 may comprise a program, service, task, script, library, application or any type and form of executable instructions or code executable on one or more processors. Security awareness system 120 may be implemented by one or more modules, applications, programs, services, tasks, scripts, libraries, applications, or executable code.

In some embodiments, security awareness system 120 may be owned or managed or otherwise associated with an organization or any entity authorized thereof. In an implementation, security awareness system 120 may manage cybersecurity awareness for the organization. In an example, security awareness system 120 may perform simulated phishing campaigns on all users within the organization. In an example, the organization may be an entity that is subscribed to or makes use of services provided by security awareness system 120. The organization may encompass all users, vendors to the organization, or partners of the organization. In an implementation, security awareness system 120 may be a platform that monitors, identifies, and manages cybersecurity attacks including phishing attacks faced by the organization or by the users within the organization. In an example, a user of the organization may include an individual that can or does receive an electronic message. For example, the user may be an employee of the organization, a member of a group, an individual who acts in any capacity of security awareness system 120, such as a system administrator, or anyone associated with the organization. The system administrator may be a professional (or a team of professionals) managing organizational cybersecurity aspects. The system administrator may oversee and manage security awareness system 120 to ensure cybersecurity goals of the organization are met. For example, the system administrator may oversee Information Technology (IT) systems of the organization for managing simulated phishing campaigns, identification and classification of threats within reported emails, selection of simulated phishing messages, and any other element within security awareness system 120. Examples of the system administrator include an IT department, a security team, a manager, or an Incident Response (IR) team. A simulated phishing campaign is a technique of testing a user to determine whether the user is likely to recognize a true malicious phishing attack and act appropriately upon receiving the malicious phishing attack. A simulated phishing message may mimic a real phishing message and appear genuine to entice a user to respond/interact with the simulated phishing message. The simulated phishing message may include links, attachments, macros, or any other simulated phishing threat that resembles a real phishing threat.

According to some embodiments, security awareness system 120 may include processor 206 and memory 208. For example, processor 206 and memory 208 of security awareness system 120 may be CPU 121 and main memory 122, respectively, as shown in FIG. 1C and FIG. 1D. According to an embodiment, security awareness system 120 may include determination unit 210, grouping unit 212, benchmarking unit 214, displaying unit 216, training unit 218, and rewarding unit 220. In an implementation, determination unit 210, grouping unit 212, benchmarking unit 214, displaying unit 216, training unit 218, and rewarding unit 220 may be applications or programs communicatively coupled to processor 206 and memory 208. In some embodiments, determination unit 210, grouping unit 212, benchmarking unit 214, displaying unit 216, training unit 218, and rewarding unit 220, amongst other units, may include routines, programs, objects, components, data structures, etc., which may perform particular tasks or implement particular abstract data types. Determination unit 210, grouping unit 212, benchmarking unit 214, displaying unit 216, training unit 218, and rewarding unit 220 may also be implemented as signal processor(s), state machine(s), logic circuitries, and/or any other device or component that manipulate signals based on operational instructions.

In some embodiments, determination unit 210, grouping unit 212, benchmarking unit 214, displaying unit 216, training unit 218, and rewarding unit 220 may be implemented in hardware, instructions executed by a processing module, or by a combination thereof. In examples the processing module may be CPU 121 as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, determination unit 210, grouping unit 212, benchmarking unit 214, displaying unit 216, training unit 218, and rewarding unit 220 may be machine-readable instructions which, when executed by a processor/processing module, perform intended functionalities of determination unit 210, grouping unit 212, benchmarking unit 214, displaying unit 216, training unit 218, and rewarding unit 220. The machine-readable instructions may be stored on an electronic memory device, hard disk, optical disk, or other machine-readable storage medium or non-transitory medium. In an implementation, the machine-readable instructions may also be downloaded to the storage medium via a network connection. In an example, machine-readable instructions may be stored in memory 208.

Referring again to FIG. 2, in some embodiments, security awareness system 120 may include user record storage 222, skill-based assessment storage 224, and quiz and test storage 226. In an implementation, quiz and test storage 226 may include quizzes or tests that may be conducted for users of the organization. User record storage 222 may include a user record for each user of the users of security awareness system 120. User records may include information about the user that is related to the determination of the security maturity of the user. In examples, a user record in user record storage 222 includes the user's results of quizzes or tests taken by the user. In an implementation, the quizzes or tests may be conducted by an organization to evaluate security knowledge of the users. In examples, quizzes or tests may be retrieved by security awareness system 120 from quiz and test storage 226 and provided to the user. User records in user record storage 222 may also include risk scores of the users.

In an example, a security knowledge of a user may refer to an understanding gained by training (for example, security awareness training), or aspects of security awareness. Examples of the security knowledge may include “do not execute an application received from outside the organization” and “enable two-step authentication on an email account.” In an implementation, the results of quizzes or tests may be stored in user records in user record storage 222 in the form of scores, such as quiz scores or test scores. Further, a risk score of a user stored in the user's user record in user record storage 222 may include a representation of the susceptibility of the user to a malicious attack. Also, the risk score for the user may quantify a cybersecurity risk that the user poses to the organization. In an example, the risk score of the user may reflect an aspect of the security knowledge of the user. According to an example, a higher risk score of a user indicates that a higher security risk is associated with the user and a lower risk score indicates that a lower security risk is associated with the user.

According to an implementation, skills-based assessment storage 224 may store results of one or more skills-based assessments of a user. In examples, a skills-based assessment that assesses security knowledge may be referred to as a Security Awareness Proficiency Assessment or SAPAs. In examples, security awareness system 120 may retrieve skill-based assessments from skills-based assessment storage 224 and may conduct skills-based assessments of users of the organization. In an example, a skills-based assessment may measure a security knowledge of a user over one or more of the following areas of security knowledge: email security, incidence reporting, Internet use, mobile devices, passwords and authentication, general security awareness, and/or social media use. In an implementation, a skills-based assessment may be administered to a user by a system administrator.

In an implementation, user records in user record storage 222 may store results of one or more simulated phishing campaigns of the users. The one or more simulated phishing campaigns may be sent to the users to test and develop cybersecurity awareness. The one or more simulated phishing campaigns may be carried out by security awareness system 120 for specific purposes including giving enhanced training to more vulnerable groups in the organization. In an example, security awareness system 120 may initiate the one or more simulated phishing campaigns based on communicating simulated phishing messages to users of the organization.

According to an implementation, user records in user record storage 222 may include the user's class categorization. Security awareness system 120 may define one or more classes of users. In some examples, a class of users may include users with the same or similar security maturity levels or security maturity scores. In an implementation, the system administrator may identify the one or more classes of users based on security maturity levels or security maturity scores of the users. According to an implementation, a predetermined range of security maturity levels or scores associated with each class of users may be used to assign a class categorization to a user which may be stored in the user's record in user record storage 222. In examples, assigning a class categorization to a user may be referred to as categorizing a user and user may be categorized into a class of users which may be stored in the user's record in user record storage 222. A predetermined range of security maturity levels or scores of a class of users may include one or more of a lower bound of a security maturity level or score and an upper bound of a security maturity level or score. In an example, for the purpose of benchmarking or comparison of users, users with the same or similar security maturity levels or security maturity scores may be grouped together in a class of users and benchmarked against each other or compared with each other.

Information stored in user records in user record storage 222, for example information related to user quiz scores, user test scores, user risk scores, information related to the results of one or more skills-based assessments conducted for users, information related to the results of one or more simulated phishing campaigns of users, and/or information related to class categorizations of users, may be periodically or dynamically updated. In an example, such information is updated by adding the new scores, results, and categorizations to user records with an indication that the latest information added is current and older information is not current but is not removed from the user record. In an example, such information is updated by replacing existing scores, results, and categorizations in user records with updated scores, results, and categorizations, and older information is removed from the user record. In an implementation, user record storage 222, skills-based assessment storage 224, and quiz and test storage 226 may include any type or form of storage, such as a database or a file system coupled to memory 208.

Referring again to FIG. 2, in some embodiments, user device 202-1 may be any device used by a user. The user may be an employee of an organization, a client, a vendor, a customer, a contractor, or any person associated with the organization. User device 202-1 may be any computing device, such as a desktop computer, a laptop, a tablet computer, a mobile device, a Personal Digital Assistant (PDA), or any other computing device. In an implementation, user device 202-1 may be a device, such as client device 102 shown in FIG. 1A and FIG. 1B. User device 202-1 may be implemented by a device, such as computing device 100 shown in FIG. 1C and FIG. 1D. According to some embodiments, user device 202-1 may include processor 230-1 and memory 232-1. In an example, processor 230-1 and memory 232-1 of user device 202-1 may be CPU 121 and main memory 122, respectively, as shown in FIG. 1C and FIG. 1D. User device 202-1 may also include user interface 234-1, such as a keyboard, a mouse, a touch screen, a haptic sensor, a voice-based input unit, or any other appropriate user interface. It shall be appreciated that such components of user device 202-1 may correspond to similar components of computing device 100 in FIG. 1C and FIG. 1D, such as keyboard 126, pointing device 127, I/O devices 130a-n and display devices 124a-n. User device 202-1 may also include display 236-1, such as a screen, a monitor connected to the device in any manner, or any other appropriate display. In an implementation, user device 202-1 may display received content (for example, messages) for the user using display 236-1 and is able to accept user interaction via user interface 234-1 responsive to the displayed content.

Referring again to FIG. 2, in some embodiments, user device 202-1 may include email client 238-1. In one example implementation, email client 238-1 may be a messaging application installed on user device 202-1. In another example implementation, email client 238-1 may be an application that can be accessed over network 204 without being installed on user device 202-1. In an implementation, email client 238-1 may be any application capable of composing, sending, receiving, and reading email messages. In an example, email client 238-1 may facilitate a user to create, receive, organize, and otherwise manage email messages. In an implementation, email client 238-1 may be an application that runs on user device 202-1. In some implementations, email client 238-1 may be an application that runs on a remote server or on a cloud implementation and is accessed by a web browser. For example, email client 238-1 may be an instance of an application that allows viewing of a desired message type, such as any web browser, Microsoft Outlook™ application (Microsoft, Mountain View, Calif.), IBM® Lotus Notes® application, Apple® Mail application, Gmail® application (Google, Mountain View, Calif.), WhatsApp™ (Facebook, Menlo Park, Calif.), a text messaging application, or any other known or custom email application. In an example, a user of user device 202-1 may be mandated to download and install email client 238-1 by the organization. In another example, email client 238-1 may be provided by the organization as default. In some examples, a user of user device 202-1 may select, purchase and/or download email client 238-1 through an application distribution platform. In some examples, user device 202-1 may receive simulated phishing messages via email client 238-1.

For ease of explanation and understanding, the description provided above is with reference to user device 202-1, however, the description is equally applicable to remaining user devices 202-(2-N).

According to an implementation, to give insight and to facilitate improvement of cybersecurity of an organization or of a group of users within the organization, security awareness system 120 may be configured to determine security maturity of individual users within the organization at one or more points in time. The description hereinafter is explained with reference to determination of a security maturity for a single user for the purpose of simplicity and should not be construed as a limitation.

In an example, security maturity may be a metric incorporating measurements of security knowledge, security awareness, and security culture which, when combined together, give a measurement of the maturity of a user with regard to cybersecurity awareness. The metric may communicate a picture of how the user contributes to the security of the organization and the areas in which the user may improve. The security maturity of the user may be determined based on a combination of security maturity dimensions. Examples of security maturity dimensions include the security knowledge of the user, the security awareness of the user, and the security culture of a group of the user or the organization of the user. Security knowledge may refer to an understanding, gained by training, or aspects of security awareness. An example of security knowledge includes the knowledge that suspicious emails often include links that can be actuated. Security awareness of the user may refer to an awareness of the user that security threats exist, leading to suspicion applied to received messages broadly without necessarily knowing how to identify the actual threats. Further, security culture may be applicable to a group or to an organization as a whole. Security culture may be defined by signaling of the importance of security awareness (or lack thereof) for example by behavior modeling by executives and senior leaders, propaganda prominently displayed, incentives or punishments related to security awareness, and champions for security within an organization. Each security maturity dimension for the user may be considered individually or two or more security maturity dimensions for the user may be combined together to determine the security maturity of the user.

In an implementation, the security maturity of the user may take the form of a numerical score, a level, or a binary measurement such as yes or no. In an example, a score may be a measure of a security maturity dimension or of security maturity that is quantitative instead of qualitative. A score may be expressed for example, as a percentage between 0% and 100%, or as a number between 0 and 10. Further, in an example, a level may be a measure of a security maturity dimension or of security maturity that is qualitative instead of quantitative. A range of scores may be mapped into one level, and one level may be mapped to a score. Examples of the level include low, medium, and high. Examples of the level may also include beginning, moderate, advanced, and expert. The manner in which security awareness system 120 may determine the security maturity of the user is described hereinafter.

According to an implementation, determination unit 210 may be configured to determine a first value for a security knowledge level or a security knowledge score of a user. The security knowledge level of the user may refer to a qualitative measure of a security knowledge of the user. Further, the security knowledge score may refer to a quantitative measure of the security knowledge of the user. Further, determination unit 210 may be configured to determine a second value for a security awareness level or a security awareness score of the user. The security awareness level of the user may refer to a qualitative measure of a security awareness of the user. Further, the security awareness score may refer to a quantitative measure of the security awareness of the user. In an example, the security awareness of the user may refer to awareness of aspects of cybersecurity, for example, email security, and the user's understanding of the importance of security awareness of users in the organization to overall cybersecurity of the organization. Furthermore, determination unit 210 may be configured to determine a third value for a security culture level or a security culture score of a group of the user. In an example, the group of the user may be a group to which the user is assigned. In an example, the group of the user may be the organization of the user. The security culture level may refer to a qualitative measure of a security culture of the group of the user. Further, the security culture score may refer to a quantitative measure of a security culture of the group of the user. The security culture may be defined by attributes of the organization or of a group within the organization in which the user is based. In an example, the security culture of the organization or of a group within the organization may be measured across different security culture components of the organization or of a group within the organization, for example attitudes, behaviors, cognition, communication, compliance, norms, and responsibilities.

The manners in which determination unit 210 may determine a security knowledge level or a security knowledge score of the user, a security awareness level or a security awareness score of the user, and/or a security culture level or a security culture score of the group of the user is described in greater detail below.

I. Determination of a Security Knowledge Level or a Security Knowledge Score of a User

In an implementation, determination unit 210 may determine a security knowledge level or a security knowledge score of a user based on one or more security knowledge components, where the one or more security knowledge components may include results of quizzes or tests, detection of behaviors of the user, skills-based assessments of the user, a risk score of the user, and results of one or more simulated phishing campaigns of the user.

A) Results of Quizzes or Tests

In an implementation, determination unit 210 may retrieve results of quizzes or tests pertaining to a user from the user's record in user record storage 222. Results of quizzes or tests may be stored in user records in user record storage 222 in the form of scores, such as quiz scores or test scores. In an example, scores of the user pertaining to one or more quizzes or tests may be numerical values. In examples, numerical values representing scores of the user pertaining to one or more quizzes or tests may be scaled to a pre-determined range, for example, between 0 and 3. According to an example, scores of the user pertaining to one or more quizzes or tests may contribute to the security knowledge level or the security knowledge score of the user. In an example, the original unscaled quiz scores or test scores of the user or scaled quiz scores or test scores of the user may be security knowledge components of the security knowledge level or the security knowledge score.

B) Detection of Behaviors of a User

According to an implementation, determination unit 210 may assess behavior of a user and may assign a user behavior score to the user based on the behavior of the user. In some examples, the behavior of a user may be monitored by a security awareness system or a security endpoint appliance and behavior events associated with the user stored in an event log or record of the user. Determination unit 210 may interface or parse an event log or record of the user generated by a security awareness system or a security endpoint appliance, for example using an API or shared memory access to an event log or record storage. In an example, an email exposure check may be used as a proxy for assessing the behavior of the user. In an example, the user behavior score may be a quantitative measurement. For example, the user behavior score may be assigned based on a number of simulated phishing messages detected or reported by the user over a period of time, or a number of times the user changes a login password in a period of time, such as a month, a quarter, half year, or a year. In some examples, the user behavior score may be a numerical value that may be scaled to a pre-determined range, for example, between 0 to 3.

In some examples, the user behavior score may be based on a qualitative measurement. For example, the user behavior score may be assigned based on whether the user regularly changes a login password without being prompted. In examples, a user behavior score may be determined by assigning a qualitative measurement a numerical value, for example, determination unit 210 may assign a user behavior score of “3” to the user if the user changes a login password every month. In some example implementations, determination unit 210 may assign a user behavior score of “2” to the user if the user changes a login password every quarter. In some example implementations, determination unit 210 may assign a user behavior score of “1” to the user if the user changes a login password when prompted. In some example implementations, determination unit 210 may assign a user behavior score of “0” to the user if the user has never changed a login password. In some implementations, determination unit 210 may assign a user behavior score individually to different user behaviors. In an implementation, the user behavior score may be a security knowledge component of the security knowledge level or the security knowledge score. In examples where more than one user behavior score has been determined, for example, for different user behaviors, each user behavior score may individually be a security knowledge component of the security knowledge level or the security knowledge score. In an example, two or more user behavior scores may be combined or aggregated, and the aggregation of the two or more user behavior scores may be a security knowledge component of the security knowledge level or the security knowledge score.

C) Skills-Based Assessment of a User

In an implementation, determination unit 210 may assess the security knowledge of the user based on one or more skills-based assessments of the user. An example of a skills-based assessment of a user is a Security Awareness Proficiency Assessment or SAPA. In an example implementation, determination unit 210 may assess the security knowledge of the user based on results of one or more skills-based assessments such as those stored in skills-based assessment storage 224. In an implementation, determination unit 210 may retrieve results of one or more skills-based assessments of a user from the user's record in user record storage 222. In an implementation, determination unit 210 may assign one or more skills-based assessments scores to the user based on the results of the one or more skills-based assessments. A skills-based assessment score may be a numerical value that may be scaled to a pre-determined range, for example, between 0 to 3. In an example, a skills-based assessment score may be indicative of the security knowledge of the user. In an example, a skills-based assessment score or a scaled skills-based assessment score may be a component of the security knowledge level or the security knowledge score. In scenarios where more than one skills-based assessment has been administered to the user (for example, a different skills-based assessment may be administered to the user to test the user for different skills), each skills-based assessment result or score may individually be a security knowledge component of the security knowledge level or the security knowledge score, or two or more skills-based assessment scores may be combined or aggregated, and the aggregation of the two or more skills-based assessment scores may be a security knowledge component of the security knowledge level or the security knowledge score.

D) Risk Score of a User

In an example, a security awareness system maintains a numerical risk score for a user. In an implementation, determination unit 210 may retrieve the risk score of the user from the user's record in user record storage 222. In an example, the risk score may be a numerical value that may be scaled to a pre-determined range, for example, between 0 to 3. The unscaled risk score or the scaled risk score of the user may be a security knowledge component of the security knowledge level or the security knowledge score.

E) Results of Simulated Phishing Campaigns of a User

In an example, a security awareness system performs simulated phishing campaigns on a user. According to an implementation, determination unit 210 may retrieve results of simulated phishing campaigns of the user from the simulated phishing campaign data in the user's record stored in user record storage 222. In an implementation, determination unit 210 may analyze results of simulated phishing campaigns of the user to determine a phish prone percentage of the user. The phish prone percentage of the user may be a metric representing a proportion of simulated phishing attacks or real phishing attacks that the user has failed out of a total of simulated phishing attacks or real phishing attacks the user has received. In some examples, a user's phish prone percentage may reflect the security knowledge of the user. In some examples, a user's phish prone percentage may be assigned a qualitative value or may be scaled to a pre-determined score range, for example, between 0 and 3. In an example implementation, a quantitative value of the phish prone percentage of a user may be assigned a qualitative value. In some examples, the quantitative value of the phish prone percentage of a user may be scaled to a pre-determined score range, for example, between 0 to 3. In an example, a qualitative value or a quantitative value representing the phish prone percentage may be a security knowledge component of the security knowledge level or the security knowledge score of the user.

In an implementation, determination unit 210 may analyze the results of simulated phishing campaigns and categorize the results based on types of delivery methods, for example, email, Short Message Service (SMS), in-person, web, mobile, etc., and/or content types used, for example, Uniform Resource Locators (URL), attachments, macros, etc. In an example, the results of simulated phishing campaigns may be assigned a different qualitative value or scaled to a different pre-determined score range depending on the types of delivery methods and/or the content types used. In an example implementation, the security knowledge level or the security knowledge score may be dependent on one or more actions that the user took in response to the simulated phishing campaigns. For example, different security knowledge levels or security knowledge scores may be assigned to the user depending on whether the user opened an email, clicked on a link, opened an attachment to the email, clicked on an exploit-enabled test, enabled a macro in an attachment when opening it, replied to the email, forwarded the email, or reported the email.

II. Determination of a Security Awareness Level or a Security Awareness Score of a User

According to an implementation, determination unit 210 may determine a security awareness level or a security awareness score of a user. In an implementation, the user may be classified into a security awareness level and assigned a corresponding security awareness score. In an example, a higher security awareness level or score may represent greater security awareness and a lower security awareness level or score may represent lesser security awareness. In an example, a fixed number of security awareness levels may be defined. For example, the security awareness levels may include one or more of an undefined security awareness level, a compliance-driven security awareness level, a Basic Awareness & Information Dissemination (BAID) security awareness level, and a behavior-shaped security awareness level.

A) Undefined Security Awareness Level

A user who has not been exposed to formal or informal security awareness information may be assigned an undefined security awareness level. The security awareness information may refer to all types of information which may include facts and truth, misinformation, propaganda, and fake news. In an example, the user may have exposed herself or himself to aspects of security awareness information, however this exposure may happen outside of the organization, and as such there may be no structured or detailed knowledge of exposure prior to the user becoming part of the organization. As a result, the security awareness level may be considered as undefined. In an example, the undefined security awareness level may be assigned a security awareness score of “0”, for example, in a range of 0 to 10.

B) Compliance-Driven Security Awareness Level

A user who performs aspects of security-aware behavior or complies to security awareness requirements which are required from him or her as a part of compliance requirements within an organization may be assigned a compliance-driven security awareness level. In an example, security awareness requirements that are part of the compliance requirement for the organization may have been provided to the user as a part of an onboarding process or as a part of an annual security awareness refresher course. According to an example, the user may have the compliance-driven security awareness level if, outside of organization-initiated compliance-focused initiatives, the user may not have sought or been exposed to any additional or updated security awareness information. In an example, the compliance-driven security awareness level may be assigned a security awareness score of “2”, for example, in a range of 0 to 10.

C) Basic Awareness & Information Dissemination (BAID) Security Awareness Level

A user who is occasionally or frequently trained on aspects of security awareness may be assigned a BAID security awareness level. In an example, a BAID security awareness level of a user may be classified as “low” where the user engages only with necessary learning. In some examples, a BAID security awareness level of a user may be classified as “medium” where the user engages with regular learning or engages with learning at regular intervals. In some examples, a BAID security awareness level of a user may be classified as “high” where the user engages with specific role-based learning across many learning delivery mechanisms.

D) Behavior-Shaped Security Awareness Level

A user who is regularly exposed to simulated phishing campaigns and other programs related to security awareness training which may be designed to influence the behavior of the user over a period of time may be assigned to a behavior-shaped security awareness level. A behavior-shaped security awareness level may further be classified into sub-levels based on the availability of more detailed information about the user. In an example, the behavior-shaped security awareness level of a user may be classified as “low” when only simple measurements, such as click rate, or the rate at which the user interacts with a simulated phishing message in a simulated phishing campaign, is logged. In some examples, the behavior-shaped security awareness level of a user may be classified as “medium” when the user is exposed to, and/or responds positively to, security awareness training that is tailored to human nature. In some examples, the behavior-shaped security awareness level of a user may be classified as “high” where the user is exposed to training and/or simulated phishing campaigns that include both positive benefit dissemination and negative impact correction.

In an example, the security awareness level of a user may be binary. For example, the security awareness level of a user may be determined to be either true or false, or yes or no. In an example, a binary security awareness level of a user may be mapped to a quantitative security awareness score for a user based on a look-up. According to an example, a look-up to convert a binary security awareness level into a quantitative security awareness score may be universal across one or more security awareness components. According to some examples, a look-up to convert a binary security awareness level into a quantitative security awareness score may be specific to a security awareness component. For example, a security awareness level of “no” may be mapped to a security awareness score of “0”, and a security awareness level of “yes” may be mapped to a security awareness score of “10”. In some examples, a security awareness level of “true” may be mapped to a security awareness score of “1” and a security awareness level of “false” may be mapped to a security awareness score of “0”. In some examples, a quantitative security awareness score representing a binary security awareness level of a user may be scaled, weighted, or normalized from one set of numerical values to another set of numerical values for use or storage.

III. Determination of a Security Culture Level or a Security Culture Score of a Group of a User

According to an implementation, determination unit 210 may be configured to determine a security culture level or a security culture score of a group of a user. In an example, a high security culture level or a high security culture score may be achieved by the group of the user by the organization deliberately embedding security-related values, beliefs, and behaviors into the working environment of the group of the user. In some examples, a high security culture level or a high security culture score may be achieved by the group of the user by use of social pressures in the group of the user, such as public rewards or criticism of the security awareness behavior of users in the group of the user. In some examples, a high security culture level or a high security culture score may be achieved by the group of the user by use of continuous reinforcement of the value that the group of the user places on security awareness and cybersecurity awareness. In some examples, a high security culture level or a high security culture score may be achieved by the group of the user based on behavior of users of the group of the user which are in positions of leadership or influence within the group of the user.

According to an implementation, determination unit 210 may determine a security culture level or a security culture score of the group of the user based on one or more of security policies of the group of the user, security communications to the group of the user, or security incentives offered to the group of the user. In an example, security policies enacted by the group of the user may be indicative of, or may influence, a security culture level or a security culture score of the group of the user. An example of a security policy that may be indicative or, or may influence, a security culture level or a security culture score is the severity of consequences to users in the group of the user for failing simulated phishing tests and/or the security incentives offered to users on the group of the user for passing simulated phishing tests. In an example, the extent to which security policies and/or security incentives of the group of the user are made publicly available or are publicly displayed may be a contributing factor to a security culture level or a security knowledge score of the group of the user. In examples, the use of gamification related to security maturity in a group of the user may be a contributing factor to a security culture level or security culture score of the group of the user. In some examples, security communications to the group of the user regarding cybersecurity policies, discussions around cybersecurity policies by a leader or an executive of the group of the user, cybersecurity-centric special events provided to the group of the user, and milestones for security awareness achievements provided to users of the group of the user may contribute to a security culture level or a security culture score of the group of the user.

According to an example implementation, security culture of a group may be measured by surveying users within the group and by making an aggregated assessment of the results of that survey. A user within a group may respond to a security culture survey via a skills-based assessment such as a SAPA. Examples of questions that a security culture survey may ask include “Does the group care about security?”, “Which teams of the group are least/most security-minded?”, “Which users of the group are most risk-averse?”, “How strong or weak is the security culture of the group?”, “In what part of the group does security culture need to improve?”, and “How effective is any security culture program?”.

In an example, the security culture level of the group of the user may be binary. For example, the security culture level of the group of the user may be determined to be either true or false, or yes or no. In some examples, a binary security culture level may be mapped to a quantitative security culture score by a look-up. In an example, a look-up to convert a binary security culture level into a quantitative security culture score may be universal across one or more security culture components. In some examples, a look-up to convert a binary security culture level into a quantitative security culture score may be specific to a security culture component. For example, a security culture level of “no” may be mapped to a security culture score of “0”, and a security culture level of “yes” may be mapped to a security culture score of “10”. In an example, a security culture level of “true” may be mapped to a security culture score of “1” and a security culture level of “false” may be mapped to a security culture score of “0”. In some examples, a quantitative security culture score representing a binary security culture level of the group of the user may be scaled, weighted, or normalized from one set of numerical values to another set of numerical values for use or storage. In an example, the security culture level or the security culture score of an organization may be a combination or aggregation of the security culture levels or scores of one or more groups of the organization.

IV. Determination of a Security Maturity Level or Score of a User

Once determined, each dimension of security maturity of a user, for example security knowledge, security awareness, and security culture for the group of the user, may be considered individually or may be combined by determination unit 210 to create an aggregate or combinational security maturity level or score. In examples, the security knowledge level or the security knowledge score of the user, the security awareness level or the security awareness score of the user, and the security culture level or the security culture score of the group of the user are determined. Determination unit 210 may be configured to determine the security maturity of the user based at least on a function of the security knowledge level or the security knowledge score of the user, the security awareness level or the security awareness score of the user, and the security culture level or the security culture score of the group of the user. In an example implementation, the security maturity of the user may take the form of a security maturity score or a security maturity level.

According to an implementation, grouping unit 212 may be configured to group the user into a class of users comprising one or more additional users, where the security maturity level or score, which may be referred to as the security maturity value of the user, falls within a predetermined range of security maturity values associated with the class of users. In an implementation, grouping unit 212 may be configured to group the user into the class of users by adding the user to the class of users. According to an implementation, the predetermined range of security maturity values of the class of users may include one or more of a lower bound of a security maturity value and an upper bound of a security maturity value.

In an implementation, benchmarking unit 214 may further be configured to benchmark, or form a comparison, of a phish prone percentage of a user with a phish phone percentage of one of the one or more additional users of the class of users that the user belongs to. In an implementation, benchmarking unit 214 may benchmark the phish prone percentage of a user with the phish phone percentage of the one or more additional users of the class of users that the user belongs to, based on determining whether the phish prone percentage of the user is greater than or less than the phish phone percentage one or more users of the one or more additional users of the class of users that the user belongs to. According to an implementation, displaying unit 216 may be configured to display the benchmarking of the phish prone percentage of the user and the phish phone percentage of one of the one or more additional users of the class of users that the user belongs to. In an implementation, displaying unit 216 may create a graphical representation showing a relationship between the phish prone percentage of the user and the phish prone percentage of the one or more users of the class of users that the user belongs to. In an example implementation, displaying unit 216 may display the benchmarking of the phish prone percentage of the user and the phish phone percentage of one of the one or more additional users of the class of users that the user belongs to using a bar chart, colormaps, dials, or any other visualization method.

According to an implementation, if a failure rate of a user on simulated phishing campaigns, for example as represented by a phish prone percentage of the user, is higher than the expected failure rate or phish prone percentage of users of the same security maturity level as the user, training unit 218 may be configured to provide security awareness training to the user. In an example, training material may be provided or presented to the user. The training material may include material that educates the user of the risk of interacting with suspicious messages and may train the user on precautions in dealing with unknown, untrusted, and suspicious messages. In examples, training material may be presented on display 236-1 of user device 202-1 of the user as part of, or bounded within, a “window” or a user interface element or a dialogue box. In some implementations, training unit 218 may be configured to limit the user's access to some IT functions or parts of the organization, for example if the failure rate of a user on simulated phishing campaigns or a phish prone percentage of the user is higher than the expected failure rate or phish prone percentage of users of the same security maturity level as the user. According to an implementation, if the failure rate or phish prone percentage of a user is lower than the expected failure rate or phish prone percentage of users of the same security maturity level as the user, rewarding unit 220 may define rewards for the user or provide rewards to the user. Rewards may include public recognition, monetary rewards such as gift cards, coupons, points, or any other inventive, or may provide increased access to IT functions or parts of the organization to the user.

As previously described, security maturity dimensions include security knowledge, security awareness, and group security culture. In a similar manner as described above, security maturity dimension levels or security maturity dimension scores and security maturity levels or security maturity scores of other users of the organization may be determined. In some implementations, security maturity dimension level comprises security knowledge level, security awareness level, or security culture level. In some implementations, security maturity dimension score comprises security knowledge score, security awareness score, or security culture score. With this information, meaningful comparisons between failure rates of users in the organization may be made by taking into account the security maturity of the users. In some examples, users who have low security maturity levels or security maturity scores relative to other users in the organization may be identified and appropriate actions may be taken to improve their security maturity. In an example, knowing the security maturity levels or the security maturity scores of users of the organization enables the organization to benchmark user failure rates across one or more simulated phishing campaigns in a way that aids the organization to determine which users are performing better than users with a same or similar security maturity score or a same or similar security maturity level, which may result in those users being rewarded or otherwise recognized. Similarly, knowing the security maturity levels or the security maturity scores of users enables the organization to determine which users are performing worse than users with a same or similar security maturity score or a same or similar security maturity level, which may result in those users being identified and singled out for an intervention in order to mitigate the risk they may cause to the organization.

According to an implementation, displaying unit 216 may display security maturity dimension levels or security maturity dimension scores or security maturity levels or security maturity scores of users of the organization to a system administrator or any user of security awareness system 120. In an example, security maturity dimension levels or security maturity dimension scores or security maturity levels or security maturity scores of the users may be displayed as values or levels. Based on security maturity dimension levels or security maturity dimension scores or security maturity levels or security maturity scores of the users, a system administrator may take actions to improve security maturity of the users. In an example, a system administrator may classify users based on their security maturity levels or security maturity scores. For example, a classification may consist of two categories: “needs training” and “does not need training” and users may be classified into one category or the other depending on their security maturity levels or security maturity scores. In some examples, average security maturity dimension levels or average security maturity dimension scores or average security maturity levels or average security maturity scores of users in one or more classes of users in an organization may be displayed to a system administrator. In an example implementation, displaying unit 216 may create a dashboard-type display for each user. The dashboard-type display may include a visual representation of security maturity dimension levels or security maturity dimension scores for security maturity dimensions individually and/or in combination. A system administrator may use the visual representation of the security maturity dimensions levels or the security maturity dimension scores of the users to perform or take appropriate actions.

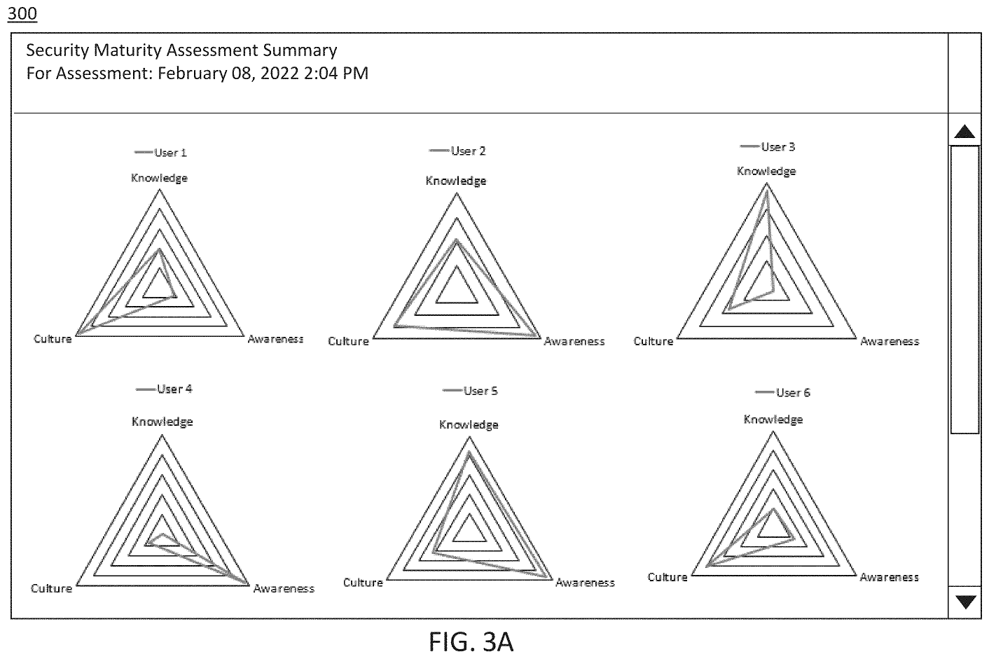

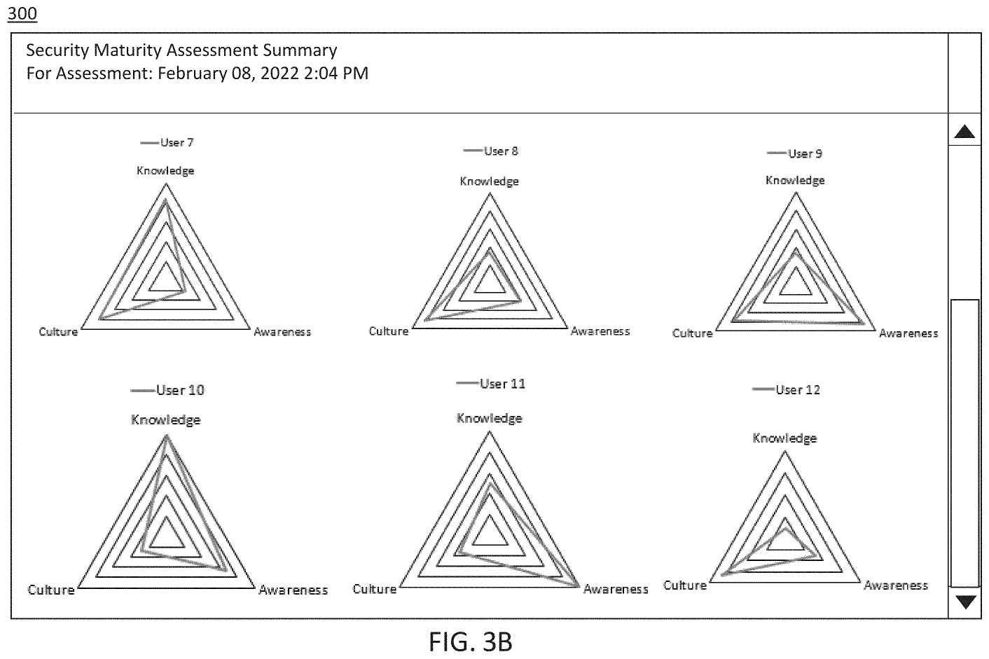

FIG. 3A and FIG. 3B depict dashboard 300 including a series of radar plots visualizing security maturity dimensions of security knowledge or “knowledge”, security awareness or “awareness”, and security culture or “culture” for twelve users, according to some embodiments. The series of radar plots may be used to visualize security maturity dimension levels or security maturity dimension scores twelve users (i.e., user 1 to user 12). In an example, dashboard 300 may be used by a system administrator for comparison of the security maturity dimensions levels or the security maturity dimension scores of the users. FIG. 3A and FIG. 3B when combined shows twelve users in a single view as a function of three security maturity dimensions, i.e., security knowledge, security awareness, and security culture. In an implementation, the area enclosed by a closed line in the shape of a triangle in each radar plot may be provided as a comparative metric between users. In examples, the number of users shown in a single view on dashboard 300 may be configured by a system administrator. In some examples, users shown in the single view may be selected based on criteria specified by a system administrator. In some examples, users shown in the single view may be selected automatically by security awareness system 120 based on, for example, rules or filters.

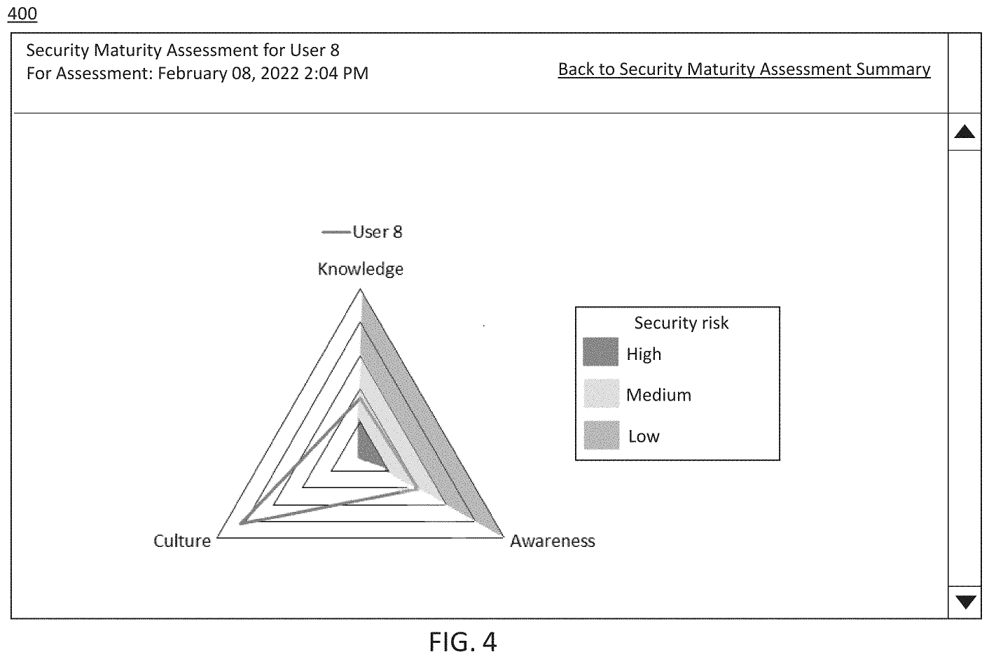

FIG. 4 depicts dashboard 400 including a radar plot visualizing an example of a security risk based on security maturity dimension levels or security maturity dimension scores of a user (for example, user 8), according to some embodiments. In particular, FIG. 4 shows an example of a security maturity level or security measure score corresponding to a measure of security risk. In the example, high security risk is equated to low security knowledge level or security knowledge score combined with low security awareness level or security awareness score. A color code of dark gray, light gray, and medium gray is used to visualize high, medium, and low measures of security risk for the user. As described in FIG. 4, the user (i.e., user 8) may be placed into a banded view of security risk by a system administrator or by security awareness system 120.

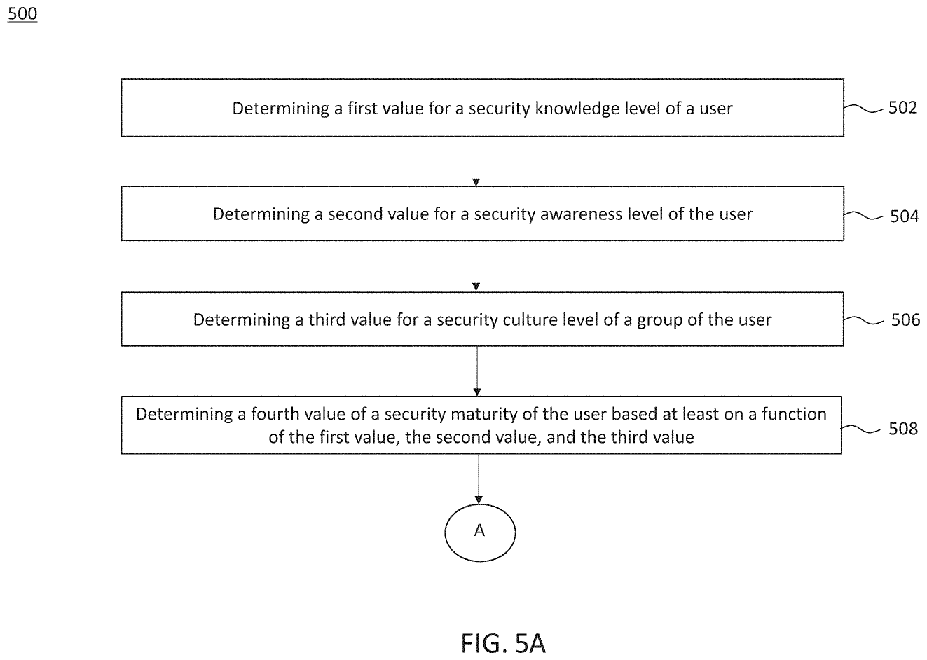

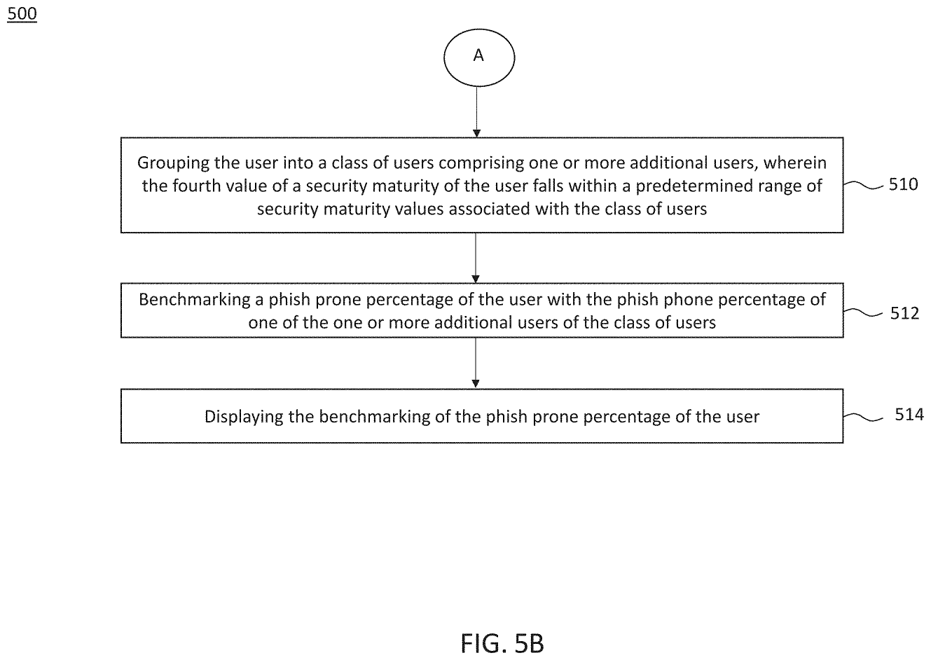

FIG. 5A and FIG. 5B depict flowchart 500 for determining a security maturity of a user, according to some embodiments.

In a brief overview of an implementation of flowchart 500, at step 502, a first value for a security knowledge level of a user is determined. At step 504, a second value for a security awareness level of the user is determined. At step 506, a third value for a security culture level of a group of the user is determined. At step 508, a fourth value of a security maturity of the user is determined based at least on a function of the first value, the second value, and the third value. At step 510, the user is grouped into a class of users comprising one or more additional users, wherein the fourth value of a security maturity of the user falls within a predetermined range of security maturity values associated with the class of users, the class of users comprising one or more additional users. At step 512, a phish prone percentage of the user is benchmarked with the phish phone percentage of one of the one or more additional users of the class of users. At step 514, the benchmarking of the phish prone percentage of the user is displayed.

Step 502 includes determining a first value for a security knowledge level of a user. According to an implementation, determination unit 210 may be configured to determine the first value for the security knowledge level of the user. In an implementation, determination unit 210 may determine the first value for the security knowledge level of the user based on one or more of results of quizzes or tests, detection of behaviors of the user, a skills-based assessment of the user, a risk score of the user, and results of one or more simulated phishing campaigns of the user. In an example, scores of the user pertaining to results of one or more quizzes or tests may be numerical values which may be scaled to a pre-determined range, for example, between 0 and 3. In an example, the original unscaled quiz scores or test scores of the user or scaled quiz scores or test scores of the user may be security knowledge components of the security knowledge level or the security knowledge score.

Determination unit 210 may assess behavior of a user and may assign a user behavior score to the user based on the behavior of the user. In some examples, the behavior of a user may be monitored by a security awareness system or a security endpoint appliance and behavior events associated with the user stored in an event log or record of the user. In an example, an email exposure check may be used as a proxy for assessing the behavior of the user. In an example, the user behavior score may be a quantitative measurement, assigned based on a number of simulated phishing messages detected or reported by the user over a period of time, or a number of times the user changes a login password in a period of time, such as a month, a quarter, half year, or a year. In some examples, the user behavior score may be a numerical value that may be scaled to a pre-determined range, for example, between 0 to 3. In some examples, the user behavior score may be based on a qualitative measurement. For example, the user behavior score may be assigned based on whether the user regularly changes a login password without being prompted. In examples, a user behavior score may be determined by assigning a qualitative measurement a numerical value. In some implementations, determination unit 210 may assign a user behavior score individually to different user behaviors. In an implementation, the user behavior score may be a security knowledge component of the security knowledge level or the security knowledge score. In examples where more than one user behavior score has been determined, for example, for different user behaviors, each user behavior score may individually be a security knowledge component of the security knowledge level or the security knowledge score. In an example, two or more user behavior scores may be combined or aggregated, and the aggregation of the two or more user behavior scores may be a security knowledge component of the security knowledge level or the security knowledge score.

In an implementation, determination unit 210 may assess the security knowledge of the user based on one or more skills-based assessments of the user. An example of skills-based assessment of a user is a Security Awareness Proficiency Assessment or SAPA. A skills-based assessment score may be a numerical value that may be scaled to a pre-determined range, for example, between 0 to 3. In an example, a skills-based assessment score may be indicative of the security knowledge of the user. In an example, a skills-based assessment score or a scaled skills-based assessment score may be a component of the security knowledge level or the security knowledge score. In scenarios where results from more than one skills-based assessment are available for a user, each skills-based assessment result or score may individually be a security knowledge component of the security knowledge level or the security knowledge score, or two or more skills-based assessment scores may be combined or aggregated, and the aggregation of the two or more skills-based assessment scores may be a security knowledge component of the security knowledge level or the security knowledge score.

In an example, a security awareness system maintains a numerical risk score for a user. In an example, the risk score may be a numerical value that may be scaled to a pre-determined range, for example, between 0 to 3. The unscaled risk score or the scaled risk score of the user may be a security knowledge component of the security knowledge level or the security knowledge score. In an implementation, determination unit 210 may analyze results of simulated phishing campaigns of the user to determine a phish prone percentage of the user. some examples, a user's phish prone percentage may reflect the security knowledge of the user. In some examples, a user's phish prone percentage may be assigned a qualitative value or may be scaled to a pre-determined score range, for example, between 0 and 3. In examples, the qualitative value or score range representing the phish prone percentage may be a security knowledge component of a security knowledge level or score. A user may fail a simulated or real phishing attack by performing an action, for example the user may fail a simulated or real phishing attack by clicking on an embedded link in the message, entering data on a landing page the user is directed to, opening an attachment to a message, enabling a macro on an attachment, replying to the message, or forwarding the simulated phishing message. In an example, the phish prone percentage of the user may reflect the security knowledge of a user. In an example implementation, a quantitative value of the phish prone percentage of a user may be assigned a qualitative value. In some examples, the quantitative value of the phish prone percentage of a user may be scaled to a pre-determined score range, for example, between 0 to 3. In an example, a qualitative value or a quantitative value representing the phish prone percentage may be a security knowledge component of the security knowledge level or the security knowledge score of the user.

In an implementation, determination unit 210 may categorize the results of simulated phishing campaigns based on types of delivery methods, for example, email, Short Message Service (SMS), in-person, web, mobile, etc., and/or content types used, for example, Uniform Resource Locators (URL), attachments, macros, etc. In an example, the results of simulated phishing campaigns may be assigned a different qualitative value or scaled to a different pre-determined score range depending on the types of delivery methods and/or the content types used. In an example implementation, the security knowledge level or the security knowledge score may be dependent on one or more actions that the user took in response to the simulated phishing campaigns. For example, different security knowledge levels or security knowledge scores may be assigned to the user depending on whether the user opened an email, clicked on a link, opened an attachment to the email, clicked on an exploit enabled test, enabled a macro in an attachment when opening it, replied to the email, forwarded the email, or reported the email.

In an example, the security knowledge level or the security knowledge score of the user may be a numerical value that may be scaled to a pre-determined range, for example, between 0 and 10. In some examples, the security knowledge level or the security knowledge score may be a sum, an average, a weighted average, or any other combination of the security knowledge components. In some examples, when two or more security knowledge components are considered (or used) for determination of the security knowledge level or the security knowledge score, a more reliable security knowledge level or the security knowledge score may be determined.

In some examples, the security knowledge level or the security knowledge score of the user may be a qualitative measurement. In an example, the security knowledge level or the security knowledge score may be determined to be low, medium, or high. In some examples, the security knowledge level or the security knowledge score may be determined to be small, medium, large, or very large. In an example, a qualitative security knowledge level may be mapped to a quantitative security knowledge score based on a look-up. According to an example, a look-up to convert a security knowledge level to a security knowledge score may be universal (or general) across one or more security knowledge components of the security knowledge level or the security knowledge score. According to some examples, a look-up to convert a security knowledge level to a security knowledge score may be specific to one or more security knowledge components of the security knowledge level or the security knowledge score. In an example, a security knowledge level of “low” may be mapped to a security knowledge score of “2”, a security knowledge level of “medium” may be mapped to a security knowledge score of “5”, and a security knowledge level of “high” may be mapped to a security knowledge score of “8”.

In some examples, a quantitative security knowledge score of the user may be mapped to a qualitative security knowledge level of the user. In an example, a quantitative security knowledge score, for example, in the range 0 to 10, may be mapped to a qualitative security knowledge level, for example, “low”, “medium”, or “high”. In some examples, a look-up may be used to map a range of quantitative security knowledge scores to a set of qualitative security knowledge levels. For example, assuming the range of security knowledge scores is a range of integer values, a security knowledge score of “0 to 3” may be mapped to a security knowledge level of “low”, a security knowledge score of “4 to 7” may be mapped to a security knowledge level of “medium”, and a security knowledge score of “8 to 10” may be mapped to a security knowledge level of “high”. In some examples, two or more security knowledge components may use the same look-up to convert a quantitative security knowledge score to a qualitative security knowledge level. In some examples, different security knowledge components may use different look-ups to convert quantitative security knowledge scores into qualitative security knowledge levels.

In an example, the security knowledge level of the user may be a binary measurement. For example, the security knowledge level of the user may be determined to be either true or false, or yes or no. According to an example, a binary security knowledge level may be mapped to a quantitative security knowledge score by a look-up. In an example, a look-up to convert a binary security knowledge level into a quantitative security knowledge score may be universal across one or more security knowledge components. In some examples, a look-up to convert a binary security knowledge level into a quantitative security knowledge score may be specific to a security knowledge component. For example, a security knowledge level of “no” may be mapped to a security knowledge score of “0”, and a security knowledge level of “yes” may be mapped to a security knowledge score of “10”. In an example, a security knowledge level of “true” may be mapped to a security knowledge score of “1” and a security knowledge level of “false” may be mapped to a security knowledge score of “0”. In some examples, a quantitative security knowledge score representing a binary security knowledge level of the user may be scaled, weighted, or normalized from one set of numerical values to another set of numerical values. In an implementation, the security knowledge level or the security knowledge score may be a combination or aggregation of security knowledge levels or security knowledge scores of one or more groups of the organization.

Step 504 includes determining a second value for a security awareness level of the user. According to an implementation, determination unit 210 of security awareness system 120 may be configured to determine the second value for the security awareness level of the user. In an implementation, security awareness system 120 may classify the user into a security awareness level and assign a corresponding security awareness score. In an example, a higher security awareness level or score may represent greater security awareness and a lower security awareness level or score may represent less security awareness. In an example, a fixed number of security awareness levels may be defined and the user may be assigned to one of the fixed number of security awareness levels. For example, the security awareness levels may include one or more of an undefined security awareness level, a compliance-driven security awareness level, a Basic Awareness & Information Dissemination (BAID) security awareness level, and a behavior-shaped security awareness level.

A user that has not been exposed to formal or informal security awareness information may be assigned an undefined security awareness level. Security awareness information may refer to several types of information related to security which may include facts and truth, misinformation, propaganda, and fake news. In an example, a user may have had or does have exposure to security awareness information, however this exposure happened or may happen outside of the organization. In examples, the security awareness system may not have detailed knowledge of a user's exposure to security awareness information prior to the user becoming part of the organization. In such cases, the user may be assigned an undefined security awareness level. In an example, an undefined security awareness level may be assigned a security awareness score of “0”, for example, in a range of 0 to 10.

A user who performs aspects of security-aware behavior or complies to security awareness requirements which are required from him or her as a part of compliance requirements within an organization may be assigned a compliance-driven security awareness level. In an example, security-aware behavior or security awareness requirements that are part of compliance requirement for an organization may have been provided to a user as a part of an onboarding process or as a part of security awareness training. According to an example, a user may be assigned a compliance-driven security awareness level if, outside of security awareness requirements required by the organization, the user may not have sought or been exposed to any additional or updated security awareness information or requirements. According to an example, a user may be assigned a compliance-driven security awareness level if, outside of security-aware behavior required by the organization, the user has not demonstrated other security-aware behavior. In an example, a compliance-driven security awareness level may be assigned a security awareness score of “2”, for example, in a range of 0 to 10.

A user who is occasionally or frequently trained on aspects of security awareness may be assigned a BAID security awareness level. In an example, security awareness training provided to a user may be selected according to a job role of the user. In some examples, security awareness training provided to a user may be selected based upon the outcome of a risk assessment performed on the user. In an example, a BAID security awareness level of a user may be classified as “low” where the user engages with necessary learning. In some examples, a BAID security awareness level of a user may be classified as “medium” where the user engages with regular learning or engages with learning at regular intervals. In some examples, a BAID security awareness level of a user may be classified as “high” where the user engages with specific role-based learning across many learning delivery mechanisms. According to an example, a low BAID security awareness level may be assigned a security awareness score of “4”, a medium BAID security awareness level may be assigned a security awareness score of “5”, and a high BAID security awareness level may be assigned a security awareness score of “6”, where scores are in a range of 0 to 10.

A user who is regularly exposed to simulated phishing campaigns and other programs related to security awareness training which may be designed to influence the behavior of the user over a period of time may be assigned to a behavior-shaped security awareness level. A behavior-shaped security awareness level may further be classified into sub-levels based on the availability of more detailed information about the user. In an example, the behavior-shaped security awareness level of a user may be classified as “low” when only simple measurements, such as click rate, or the rate at which the user interacts with a simulated phishing message in a simulated phishing campaign, is logged. In some examples, the behavior-shaped security awareness level of a user may be classified as “medium” when the user is exposed to, and/or responds positively to, security awareness training that is tailored to human nature, for example, simulated phishing campaigns that leverage emotional triggers, free gifts, etc. In some examples, the behavior-shaped security awareness level of a user may be classified as “high” where the user is exposed to training and/or simulated phishing campaigns that include both positive benefit dissemination, for example, training on the impacts of good and improving security awareness, and negative impact correction, for example, simulated phishing campaigns and knowledge training based on failure. In an example, a behavior-shaped security awareness level of “low” may be assigned a security awareness score of “8”, a behavior-shaped security awareness level of “medium” may be assigned a security awareness score of “9”, and a behavior-shaped security awareness level of “high” may be assigned a security awareness score of “10”, where scores are in a range of 0 to 10.

In an example, the security awareness level of a user may be binary. For example, the security awareness level of a user may be determined to be either true or false, or yes or no. In an example, a binary security awareness level of a user may be mapped to a quantitative security awareness score for a user based on a look-up. According to an example, a look-up to convert a binary security awareness level into a quantitative security awareness score may be universal across one or more security awareness components. According to some examples, a look-up to convert a binary security awareness level into a quantitative security awareness score may be specific to a security awareness component. For example, a security awareness level of “no” may be mapped to a security awareness score of “0”, and a security awareness level of “yes” may be mapped to a security awareness score of “10”. In some examples, a security awareness level of “true” may be mapped to a security awareness score of “1” and a security awareness level of “false” may be mapped to a security awareness score of “0”. In some examples, a quantitative security awareness score representing a binary security awareness level of a user may be scaled, weighted, or normalized from one set of numerical values to another set of numerical values for use or storage.

Step 506 includes determining a third value for a security culture level of a group of the user. According to an implementation, determination unit 210 of security awareness system 120 may be configured to determine the third value for the security culture level of the group of the user. In an example, the group of the user is the organization of the user. In an implementation, determination unit 210 of security awareness system 120 may determine the third value for the security culture level of the group of the user based at least on the group to which the user is assigned. In an implementation, determination unit 210 of security awareness system 120 may determine the third value for the security culture level based on one or more of security policies of the group of the user, security communications to the group of the user, or security incentives offered to the group of the user.

In an example, a high security culture level or a high security culture score may be achieved by the group of the user by deliberately embedding security-related values, beliefs, and behaviors into the working environment of the group of the user. In some examples, a high security culture level or a high security culture score may be achieved by the group of the user by use of social pressures in the group of the user, such as public rewards or criticism of the security awareness behavior of users in the group of the user. In some examples, a high security culture level or a high security culture score may be achieved by the group of the user by user of continuous reinforcement of the value that the group of the user places on security awareness and cybersecurity awareness. In some examples, a high security culture level or a high security culture score may be achieved by the group of the user based on behavior of users of the group of the user which are in positions of leadership or influence within the group of the user.

According to an implementation, determination unit 210 may determine a security culture level or a security culture score of the group of the user based on one or more of security policies of the group of the user, security communications to the group of the user, or security incentives offered to the group of the user. In an example, security policies enacted by the group of the user may be indicative of, or may influence, a security culture level or a security culture score of the group of the user. An example of a security policy that may be indicative or, or may influence, a security culture level or a security culture score is the severity of consequences to users in the group of the user for failing simulated phishing tests and/or the security incentives offered to users on the group of the user for passing simulated phishing tests. In an example, the extent to which security policies and/or security incentives of the group of the user are made publicly available or are publicly displayed may be a contributing factor to a security culture level or a security knowledge score of the group of the user. In examples, the use of gamification related to security maturity in a group of the user may be a contributing factor to a security culture level or security culture score of the group of the user. In some examples, security communications to the group of the user regarding cybersecurity policies, discussions around cybersecurity policies by a leader or an executive of the group of the user, cybersecurity-centric special events provided to the group of the user, and milestones for security awareness achievements provided to users of the group of the user may contribute to a security culture level or a security culture score of the group of the user.

An example of a group with a low security culture level or a low security culture score is a group that has just assessed its overall security culture for a first time and is beginning to plan to address gaps. In some examples, a group with a low security culture level or a low security culture score may establish a “Culture Carrier” security awareness program or a “Security Champion” security awareness program. In some examples, a group with a low security culture level or a low security culture score may engage “Security Liaisons” to address gaps identified in the overall security culture of the group.

An example of a group with a medium security culture level or a medium security culture score is a group that has established security awareness programs which leverage for example social pressures, reinforcement, and/or continual messaging to improve security awareness. Further, an example of a group with a high security culture level or a high security culture score is a group where security values are woven through the group from the leadership down through the members of the group. For example, security values of the group may be modeled by established employees, managers, or leaders so they are seen and can influence new employees or employees at a lower organizational level in the group. Another example of a group with a high security culture level or a high security culture score is a group in which engagement with security, for example, phish reporting or reporting of other suspicious events, is celebrated, or where security issues are viewed as opportunities to inform the group through the use of stories and anecdotes.

According to an example implementation, security culture of a group may be measured by surveying users within the group and by making an aggregated assessment of the results of that survey. A user within a group may respond to a security culture survey via a skill-based assessment such as a SAPA. Examples of questions that a security culture survey may ask include “Does the group care about security?”, “Which teams of the group are least/most security-minded?”, “Which users of the group are most risk-averse?”, “How strong or weak is the security culture of the group?”, “In what part of the group does security culture need to improve?”, and “How effective is any security culture program?”.

In an example, the security culture level of the group of the user may be binary. For example, the security culture level of the group of the user may be determined to be either true or false, or yes or no. In some examples, a binary security culture level may be mapped to a quantitative security culture score by a look-up. In an example, a look-up to convert a binary security culture level into a quantitative security culture score may be universal across one or more security culture components. In some examples, a look-up to convert a binary security culture level into a quantitative security culture score may be specific to a security culture component. For example, a security culture level of “no” may be mapped to a security culture score of “0”, and a security culture level of “yes” may be mapped to a security culture score of “10”. In an example, a security culture level of “true” may be mapped to a security culture score of “1” and a security culture level of “false” may be mapped to a security culture score of “0”. In some examples, a quantitative security culture score representing a binary security culture level of the group of the user may be scaled, weighted, or normalized from one set of numerical values to another set of numerical values for use or storage. In an example, the security culture level or the security culture score of an organization may be a combination or aggregation of the security culture levels or scores of one or more groups of the organization.

Step 508 includes determining a fourth value of a security maturity of the user based at least on a function of the first value, the second value, and the third value. According to an implementation, determination unit 210 of security awareness system 120 may be configured to determine the fourth value of the security maturity of the user based at least on the function of the first value, the second value, and the third value. Security knowledge of the user, security awareness of the user, and security culture for the group of the user, may be considered individually or may be combined by determination unit 210 to create an aggregate or combinational security maturity level or score.

The security maturity score may take the form of a numerical value within a range of numerical values, for example, a number in the range of 0 to 10. In an example, the numerical value representing the security maturity score may be an integer value or a real number or value. In another example, the security maturity score of the user may be negative, such as, from within a range of −10 to +10. In some examples, the security maturity score of the user may be scaled, weighted, or normalized from one range of numerical values to another range of numerical values for use or storage.

The security maturity level may be a qualitative representation of the user performance. The security maturity level may utilize the same metrics as the security maturity score but represents the results in a qualitative way instead of numerical. In an example, the security maturity level of the user may be a qualitative measurement. For example, the security maturity level of the user may be determined to be low, medium, or high, or may be determined to be small, medium, large, or very large. According to an example, a qualitative security maturity level may be mapped to a quantitative security maturity score by way of a look-up. In an example, a look-up to convert a security maturity level to a security maturity score may be universal across one or more security maturity dimensions. In some examples, a look up to convert a security maturity level to a security maturity score may be specific to a security maturity dimension. In an example, a security maturity level of “low” may be mapped to a security maturity score of “2”, a security maturity level of “medium” may be mapped to a security maturity score of “5”, and a security maturity level of “high” may be mapped to a security maturity score of “8”.

In an example, the security maturity level of the user may be binary. For example, the security maturity level of the user may be determined to be either true or false, or yes or no. In some examples, a binary security maturity level may be mapped to a quantitative security maturity score by a look-up. In an example, a look-up to convert a binary security maturity level into a quantitative security maturity score may be universal across one or more security maturity dimensions. In some examples, a look-up to convert a binary security maturity level into a quantitative security maturity score may be specific to a security maturity dimension. For example, a security maturity level of “no” may be mapped to a security maturity score of “0”, and a security maturity level of “yes” may be mapped to a security maturity score of “10”. In an example, a security maturity level of “true” may be mapped to a security maturity score of “1”, and a security maturity level of “false” may be mapped to a security maturity score of “0”. In some examples, a quantitative security maturity score representing a binary security maturity level of the user may be scaled, weighted, or normalized from one set of numerical values to another set of numerical values for use or storage. In an example, a quantitative security maturity score of the user may be mapped to a qualitative security maturity level of the user. In an example, a quantitative security maturity score, for example in the range 0 to 10, may be mapped to a qualitative security maturity level, for example “low”, “medium”, or “high”. In an example, a look-up may be used to map a range of quantitative security maturity scores to a set of qualitative security maturity levels. For example, and assuming the range of security maturity scores is a range of integer values, a security maturity score of “0 to 3” may be mapped to a security maturity level “low”, a security maturity score of “4 to 7” may be mapped to a security maturity level of “medium”, and a security maturity score of “8 to 10” may be mapped to a security maturity level of “high”. In examples, two or more security maturity dimensions may use the same look-up to convert a quantitative security maturity score to a qualitative security maturity level, or different security maturity dimensions may use different look-ups to convert quantitative security maturity scores into qualitative security maturity levels.

In an example, the first value for the security knowledge level or the security knowledge score of the user may be represented as “u_{K}”, the second value for the security awareness level or the security awareness score of the user may be represented as “u_{A}”, and the third value for the security culture level or the security culture score of the group of the user may be represented as “u_{C}”. In an example implementation, the fourth value of the security maturity of the user may be mathematically represented by Equation (1), provided below.

U=f(u_{K},u_{A},u_{C}) (1)

where, U represents the fourth value of the security maturity (i.e., the security maturity level or the security maturity score).

According to an implementation, determination unit 210 may be configured to determine the fourth value of the security maturity of the user (i.e., the security maturity level or the security maturity score of the user) based on forming a linear combination of the security maturity dimension levels or the security maturity dimension scores (i.e., the first value for the security knowledge level or the security knowledge score of the user, the second value for the security awareness level or the security awareness score of the user, and the third value for the security culture level or the security culture score of the group of the user). In an example implementation, weighting factors for one or more of the first value for the security knowledge level or the security knowledge score of the user, the second value for the security awareness level or the security awareness score of the user, and the third value for the security culture level or the security culture score of the group of the user may be applied in a linear combination formula. In some examples, the security maturity dimensions that are represented in terms of levels may be converted into scores prior to using the security maturity dimension scores in the linear combination formula. In an example, the resulting linear combination may be scaled to a new range of outputs. In some examples, the weighting factors may achieve any scaling of the output of the linear combination. In an implementation, a set of individual security maturity dimensions may be {uₐ, u_{b}, u_{c}, u_{d}, uₑ, u_{f}}. Any number or combination or aggregation security maturity scores may be defined from the set. In an example, two combination measures of security maturity are defined as U₁ and U₂, where:

$${U}_{1} = \frac{1}{{s}_{1}} [ α {u}_{a} + β {u}_{b} + γ {u}_{c} ] and \qquad ( 2 )$$

$${U}_{2} = \frac{1}{{s}_{2}} [ δ {u}_{d} + ε {u}_{e} + ζ {u}_{f} ] \qquad ( 3 )$$

In this example, {α, β, γ, δ, ε, ζ} is a set of weighting factors and s₁ and s₂ are scaling factors for U₁ and U₂, respectively.

According to an implementation, determination unit 210 may be configured to determine the fourth value of the security maturity of the user (i.e., the security maturity level or the security maturity score of the user) based on considering each security maturity dimension level or the security maturity dimension score (i.e., each of the first value for the security knowledge level or the security knowledge score of the user, the second value for the security awareness level or the security awareness score of the user, and the third value for the security culture level or the security culture score of the group of the user) as a component of an n-dimensional vector. In an example, the security maturity level or the security maturity score may be defined as a vector norm of the components (i.e., each security maturity dimension) of the n-dimensional vector. In some examples, weighting factors for one or more of the security maturity dimension levels or the security maturity dimension scores may be applied prior to creating the n-dimensional vector. In some examples, the security maturity dimensions that are represented in terms of levels may be converted into scores prior to using the security maturity dimension scores in the n-dimensional vector. In an example implementation, {uₐ, u_{b}, u_{c}, u_{d}, uₑ, u_{f}} may be considered as security maturity dimensions of a 6-dimensional vector and combinational measures of the security maturity may be defined as norms of the dimensions of the vector which form the combinational measure of security maturity. For example, for the same two combinational security maturity scores, U₁ and U₂,

U₁=∥u₁∥=\sqrt{uₐ²+u_{b}²+u_{c}²} (4)

and

U₂=∥u₂∥=\sqrt{u_{d}²+uₑ²+u_{f}²} (5)

In some examples, the components of the n-dimensional vector may be weighted and

U₁=∥u₁∥=\sqrt{(αuₐ)²+(βu_{b})²+(γu_{c})²} (6)

and

U₂=∥u₂∥=\sqrt{(δu_{d})²+(εuₑ)²+(ζu_{f})²} (7)

Although other known examples and implementations of determining the fourth value of the security maturity of the user are contemplated herein, these need not be described in full within this disclosure. According to an implementation, determination or measurement of the security maturity of the user may be made on a periodic basis to allow detection of changes to the security maturity of the user. In an example, the changes may reflect an increasing or decreasing level of security maturity. This information may be used, for example, to determine that whether a training program is working well or is ineffective for the user.

Step 510 includes grouping the user into a class of users comprising one or more additional users, wherein the fourth value of a security maturity of the user falls within a predetermined range of security maturity values associated with the class of users. In an example, the grouping the user into the class of users may include adding the user to the class of users. According to an implementation, grouping unit 212 of security awareness system 120 may be configured to group the user into the class of users comprising one or more additional users, wherein the fourth value of a security maturity of the user falls within a predetermined range of security maturity values associated with the class of users. In an example, the predetermined range of security maturity values of the class of users includes one or more of a lower bound of a security maturity value and an upper bound of a security maturity value. The security maturity level or score of the user may be referred to as the security maturity value of the user. In an implementation, grouping unit 212 may be configured to group the user into the class of users by adding the user to the class of users.

Step 512 includes benchmarking a phish prone percentage of the user with the phish phone percentage of one of the one or more additional users of the class of users. According to an implementation, benchmarking unit 214 of security awareness system 120 may be configured to benchmark the phish prone percentage of the user with the phish phone percentage of one of the one or more additional users of the class of users. In an implementation, security awareness system 120 may benchmark the phish prone percentage of the user with the phish phone percentage of the one or more additional users based on determining whether the phish prone percentage of the user is greater than or less than the phish phone percentage one or more users of the one or more additional users. In an implementation, benchmarking unit 214 may further be configured to benchmark, or form a comparison, of a phish prone percentage of a user with the phish phone percentage of one of the one or more additional users of the class of users that the user belongs to. In an implementation, benchmarking unit 214 may benchmark the phish prone percentage of a user with the phish phone percentage of the one or more additional users of the class of users that the user belongs to, based on determining whether the phish prone percentage of the user is greater than or less than the phish phone percentage one or more users of the one or more additional users of the class of users that the user belongs to.

Step 514 includes displaying the benchmarking of the phish prone percentage of the user. According to an implementation, displaying unit 216 of security awareness system 120 may be configured to display the benchmarking of the phish prone percentage of the user. In an implementation, security awareness system 120 may create a graphical representation showing a relationship between the phish prone percentage of the user and the phish prone percentage of one or more users of the class of users and display the graphical representation. According to an implementation, displaying unit 216 may be configured to display the benchmarking of the phish prone percentage of the user and the phish phone percentage of one of the one or more additional users of the class of users that the user belongs to. In an implementation, displaying unit 216 may create a graphical representation showing a relationship between the phish prone percentage of the user and the phish prone percentage of the one or more users of the class of users that the user belongs to. In an example implementation, displaying unit 216 may display the benchmarking of the phish prone percentage of the user and the phish phone percentage of one of the one or more additional users of the class of users that the user belongs to using a bar chart, colormaps, dials, or any other visualization method.

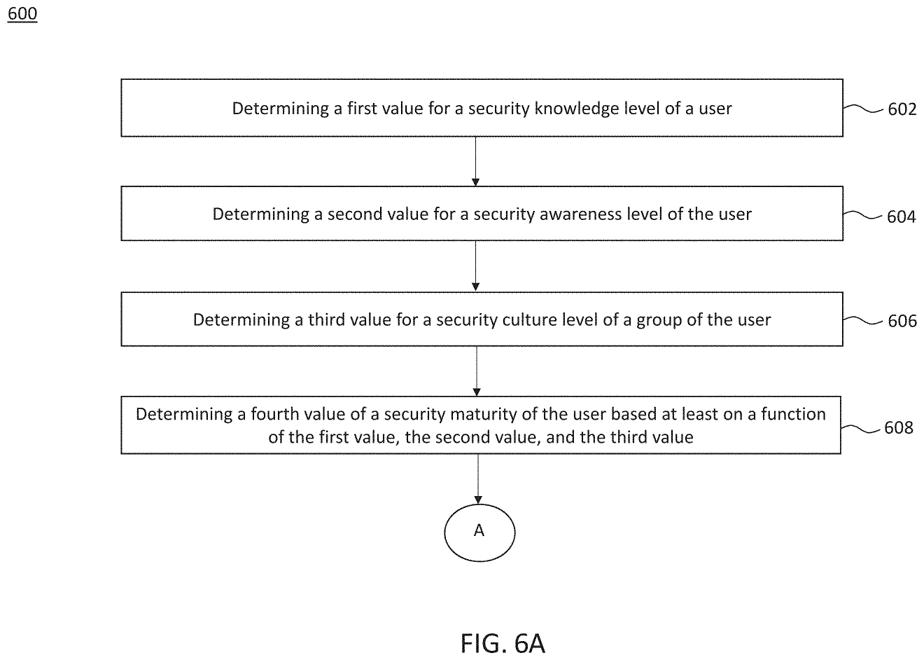

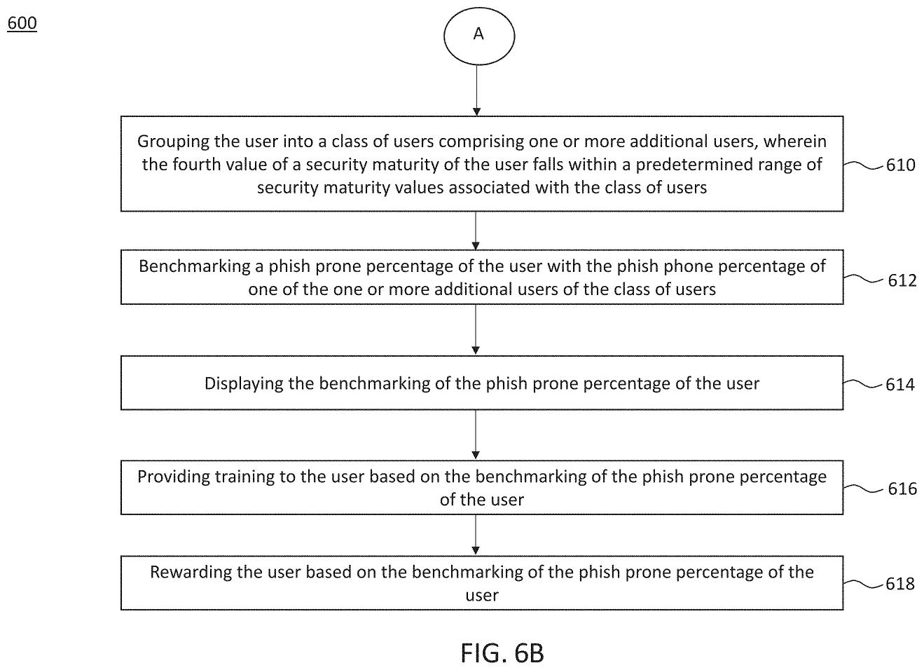

FIG. 6A and FIG. 6B depict flowchart 600 for rewarding a user based on a security maturity of a user, according to some embodiments.

In a brief overview of an implementation of flowchart 600, at step 602, a first value for a security knowledge level of a user is determined. At step 604, a second value for a security awareness level of the user is determined. At step 606, a third value for a security culture level of a group of the user is determined. At step 608, a fourth value of a security maturity of the user is determined based at least on a function of the first value, the second value, and the third value. At step 610, the user is grouped into a class of users comprising one or more additional users, wherein the fourth value of a security maturity of the user falls within a predetermined range of security maturity values associated with the class of users, the class of users comprising one or more additional users. At step 612, a phish prone percentage of the user is benchmarked with the phish phone percentage of one of the one or more additional users of the class of users. At step 614, the benchmarking of the phish prone percentage of the user is displayed. At step 616, training is provided to the user based on the benchmarking of the phish prone percentage of the user. At step 618, the user is rewarded based on the benchmarking of the phish prone percentage of the user.

Step 602 includes determining a first value for a security knowledge level of a user. According to an implementation, determination unit 210 may be configured to determine the first value for the security knowledge level of the user. In an implementation, determination unit 210 may determine the first value for the security knowledge level of the user based on one or more of results of quizzes or tests, detection of behaviors of the user, a skills-based assessment of the user, a risk score of the user, and results of one or more simulated phishing campaigns of the user. Further details about step 602 are described in relation to step 502 above.

Step 604 includes determining a second value for a security awareness level of the user. According to an implementation, determination unit 210 of security awareness system 120 may be configured to determine the second value for the security awareness level of the user. In an implementation, security awareness system 120 may classify the user into a security awareness level comprising one or more of an undefined security awareness level, a compliance-driven security awareness level, a BAID security awareness level, and a behavior-shaped security awareness level. Further details about step 604 are described in relation to step 504 above.

Step 606 includes determining a third value for a security culture level of a group of the user. According to an implementation, determination unit 210 of security awareness system 120 may be configured to determine the third value for the security culture level of the group of the user. In an example, the group of the user is the organization of the user. In an implementation, determination unit 210 of security awareness system 120 may determine the third value for the security culture level of the group of the user based at least on the group to which the user is assigned. In an implementation, determination unit 210 of security awareness system 120 may determine the third value for the security culture level based on one or more of security policies of the group of the user, security communications to the group of the user, or security incentives offered to the group of the user. Further details about step 606 are described in relation to step 506 above.

Step 608 includes determining a fourth value of a security maturity of the user based at least on a function of the first value, the second value, and the third value. According to an implementation, determination unit 210 of security awareness system 120 may be configured to determine the fourth value of the security maturity of the user based at least on the function of the first value, the second value, and the third value. Further details about step 608 are described in relation to step 508 above.

Step 610 includes grouping the user into a class of users comprising one or more additional users, wherein the fourth value of a security maturity of the user falls within a predetermined range of security maturity values associated with the class of users. In an example, the grouping the user into the class of users may include adding the user to the class of users. According to an implementation, grouping unit 212 of security awareness system 120 may be configured to group the user into the class of users comprising one or more additional users, wherein the fourth value of a security maturity of the user falls within a predetermined range of security maturity values associated with the class of users. In an example, the predetermined range of security maturity values of the class of users includes one or more of a lower bound of a security maturity value and an upper bound of a security maturity value. Further details about step 610 are described in relation to step 510 above.

Step 612 includes benchmarking a phish prone percentage of the user with the phish phone percentage of one of the one or more additional users of the class of users. According to an implementation, benchmarking unit 214 of security awareness system 120 may be configured to benchmark the phish prone percentage of the user with the phish phone percentage of one of the one or more additional users of the class of users. In an implementation, security awareness system 120 may benchmark the phish prone percentage of the user with the phish phone percentage of the one or more additional users based on determining whether the phish prone percentage of the user is greater than or less than the phish phone percentage one or more users of the one or more additional users. Further details about step 612 are described in relation to step 512 above.

Step 614 includes displaying the benchmarking of the phish prone percentage of the user. According to an implementation, displaying unit 216 of security awareness system 120 may be configured to display the benchmarking of the phish prone percentage of the user. In an implementation, security awareness system 120 may create a graphical representation showing a relationship between the phish prone percentage of the user and the phish prone percentage of one or more users of the class of users and display the graphical representation. Further details about step 614 are described in relation to step 514 above.

Step 616 may include providing training to the user based on the benchmarking of the phish prone percentage of the user. According to an implementation, training unit 218 of security awareness system 120 may be configured to provide training to the user based on the benchmarking of the phish prone percentage of the user. Based on security maturity dimension levels or security maturity dimension scores or security maturity levels or security maturity scores of the users, a system administrator may take actions to improve security maturity of the users. In an example, training unit 218 of security awareness system 120 may provide training related to cybersecurity to the user. In an example, a system administrator may classify users based on their security maturity levels or security maturity scores. For example, a classification may consist of two categories: “needs training” and “does not need training” and users may be classified into one category or the other depending on their security maturity levels or security maturity scores. In some examples, average security maturity dimension levels or average security maturity dimension scores or average security maturity levels or average security maturity scores of users in one or more classes of users in an organization may be displayed to a system administrator. In an example implementation, displaying unit 216 may create a dashboard-type display for each user. The dashboard-type display may include a visual representation of security maturity dimension levels or security maturity dimension scores for security maturity dimensions individually and/or in combination. A system administrator may use the visual representation of the security maturity dimensions levels or the security maturity dimension scores of the users to perform or take appropriate actions.

Step 618 may include rewarding the user based on the benchmarking of the phish prone percentage of the user. According to an implementation, rewarding unit 220 of security awareness system 120 may be configured to define rewards for the user based on the benchmarking of the phish prone percentage of the user. In an example, rewards may include public recognition, monetary rewards (for example, gift card, coupons, points, or any other inventive), or increased access to some IT functions or parts of the organization. According to an implementation, if the failure rate or phish prone percentage of a user is lower than the expected failure rate or phish prone percentage of users of the same security maturity level as the user, rewarding unit 220 may define rewards for the user or provide rewards to the user. Rewards may include public recognition, monetary rewards such as gift cards, coupons, points, or any other inventive, or may provide increased access to IT functions or parts of the organization to the user.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
determining, by one or more servers, a first value for a security knowledge level of a user,
determining, by the one or more servers, a second value for a security awareness level of the user;
determining, by the one or more servers, a third value for a security culture level of a group of the user;
determining, by the one or more servers, a fourth value of a security maturity of the user based at least on a function of the first value, the second value and the third value;
categorizing, by the one or more servers, the user into a class of users comprising one or more additional users, wherein the fourth value of a security maturity of the user falls within a predetermined range of security maturity values associated with the class of users, the class of users comprising one or more additional users;
benchmarking, by the one or more servers, a phish prone percentage of the user with the phish phone percentage of one or more additional users of the class of users; and
displaying, by the server, the benchmarking of the phish prone percentage of the user.

2. The method of claim 1, further comprising determining, by the one or more servers, the first value for the security knowledge level of the user based on one or more of results of quizzes or tests, detection of behaviors of the user, a skills-based assessment of the user, a risk score of the user, and the results of one or more simulated phishing campaigns of the user.

3. The method of claim 1, wherein determining, by the one or more servers, the second value for a security awareness level of the user comprises classifying the user into a security awareness level comprising one or more of an undefined security awareness level, a compliance-driven security awareness level, a BAID security awareness level, and a behavior-shaped security awareness level.

4. The method of claim 1, further comprising determining, by the one or more servers, the third value for the security culture level of the group of the user based at least on the group to which the user is assigned.

5. The method of claim 1 further comprising determining, by the one or more servers, the third value for a security culture level based on one or more of security policies of the group of the user, security communications to the group of the user, or security incentives offered to the group of the user.

6. The method of claim 1 wherein the group of the user is the organization of the user.

7. The method of claim 1, wherein the predetermined range of security maturity values associated with the class of users comprises one or more of a lower bound of a security maturity value and an upper bound of a security maturity value.

8. The method of claim 1 wherein categorizing the user into the class of users comprises adding the user to the class of users.

9. The method of claim 1, wherein benchmarking the phish prone percentage of the user with the phish phone percentage of the one or more additional users of the class of users comprises determining whether the phish prone percentage of the user is greater than or less than the phish phone percentage of one or more users of the one or more additional users of the class of users.

10. The method of claim 1, wherein displaying the benchmarking comprises creating a graphical representation showing a relationship between the phish prone percentage of the user and the phish prone percentage of one or more users of the class of users.

11. A system comprising:
one or more servers configured to:
determine a first value for a security knowledge level of a user;
determine a second value for a security awareness level of the user;
determine a third value for a security culture level of a group of the user;
determine a fourth value of a security maturity of the user based at least on a function of the first value, the second value and the third value;
categorize the user into a class of users comprising one or more additional users, wherein the fourth value of a security maturity of the user falls within a predetermined range of security maturity values associated with the class of users, the class of users comprising one or more additional users;
benchmark a phish prone percentage of the user with the phish phone percentage of one or more additional users of the class of users; and
display the benchmarking of the phish prone percentage of the user.

12. The system of claim 11, wherein the one or more servers are further configured to determine the first value for the security knowledge level of the user based on one or more of results of quizzes or tests, detection of behaviors of the user, a skills-based assessment of the user, a risk score of the user, and the results of one or more simulated phishing campaigns of the user.

13. The system of claim 11, wherein the one or more servers are further configured to determine the second value for a security awareness level of the user comprises classifying the user into a security awareness level comprising one or more of an undefined security awareness level, a compliance-driven security awareness level, a BAD security awareness level, and a behavior-shaped security awareness level.

14. The system of claim 11, wherein the one or more servers are further configured to determine the third value for the security culture level of the group of the user based at least on the group to which the user is assigned.

15. The system of claim 11, further wherein the one or more servers are further configured to determine the third value for a security culture level based on one or more of security policies of the group of the user, security communications to the group of the user, or security incentives offered to the group of the user.

16. The system of claim 11, wherein the group of the user is the organization of the user.

17. The system of claim 11, wherein the predetermined range of security maturity values associated with the class of users comprises one or more of a lower bound of a security maturity value and an upper bound of a security maturity value.

18. The system of claim 11, wherein categorizing the user into the class of users comprises adding the user to the class of users.

19. The system of claim 11, wherein benchmarking the phish prone percentage of the user with the phish phone percentage of the one or more additional users of the class of users comprises determining whether the phish prone percentage of the user is greater than or less than the phish phone percentage of one or more users of the one or more additional users of the class of users.

20. The system of claim 11, wherein displaying the benchmarking comprises creating a graphical representation showing a relationship between the phish prone percentage of the user and the phish prone percentage of one or more users of the class of users.
